(19) United States
(12) Patent Application Publication
(10) Pub. No.: US 2005/0175836 A1
(43) Pub. Date: Aug. 11, 2005

(54) Physical color new concepts for color pigments

(75) Inventors: Manfred R. Kuehnle, Lincoln, MA (US); Hermann Statz, Wayland, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: XMX Corporation, Waltham, MA (US)

(21) Appl. No.: 10/987,193

(22) Filed: Nov. 12, 2004

Related U.S. Application Data
(60) Provisional application No. 60/519,178, filed on Nov. 12, 2003.

(51) Int. Cl. B32B 5/16

(52) U.S. Cl. 428/403; 428/404

(57) ABSTRACT

An electromagnetic radiation-absorbing particle comprising a core and at least one shell. The shell encapsulates the core and either the core or the shell comprises a conductive material. In one embodiment the core comprises a first conductive material and the shell comprises a second conductive material different from the first conductive material. In another embodiment either the core or the shell comprises a refracting material.

### RELATED APPLICATION

This application claims the benefit of U.S. Provisional Application No. 60/519,178, filed on Nov. 12, 2003. The entire teachings of the above application is incorporated herein by reference.

### INTRODUCTION

We shall describe here new methods for achieving color by means other than using selective absorption through electronic transitions in atoms or molecules, such as dyes. The color will be produced by physical effects such as resonance of electromagnetic radiation in dielectric resonators of a size comparable to but smaller than a wavelength of light. A high index of refraction or equivalently a high dielectric constant is needed for selective entrapment of radiation. The absorption wavelengths and thus color exhibited will depend upon particle size. The effect can be looked at as an entrapment of resonance radiation inside the dielectric sphere followed by absorption. Even low intrinsic absorption in the dielectric will absorb all of the trapped radiation in a short time. The optical color will depend on particle size.

Alternatively color can be produced by the so-called Froehlich or plasmon resonance, which is a totally different type of resonance. In its most simple form this resonance can be described by a collective oscillation of the free electrons with respect to the relatively stationary lattice of the remaining positive ions. More formalistically one uses the fact that for a number of metallic compounds the dielectric constant can become negative in the visible spectrum. This in turn leads to a high absorption in the metal by a mechanism to be described below. Basically the electric field inside the metal sphere becomes very large for those wavelengths where the condition is satisfied that the negative value of the dielectric constant inside the sphere is equal in magnitude to twice the positive dielectric constant of the medium surrounding the sphere. The high electric light fields are then strongly absorbed because of the associated metallic conduction losses. The resonance condition and thereby the color can be moderately shifted by index changes in the carrier medium. Also coatings by either certain other metals or high dielectric constant dielectrics can be employed for producing essentially any desired colors. Also a dielectric core coated by a metal can be used to tune the resonance frequency. The absorption wavelength is not dependent on particle size as long as the particles do not become too large. Both above described resonances can lead to absorption cross sections which are larger than unity. This means that more light can be absorbed than falls onto the particles as described by geometric optics. We need to add that in any case geometric optics is not applicable for dimensions small compared to a wavelength of light. Nevertheless much less pigment is needed than with conventional colorants which are limited to lower absorption cross sections.

A third method of making color pigments is by direct band gap semiconductors, which have band gaps in the visible spectrum. They can be used either alone as fine no resonance particles or as continuous layers on a suitable substrate. Slightly larger particles with resonances that can also be employed to greatly enhance absorption near the cutoff wavelength where the intrinsic absorption is still not very strong. In the following we shall discuss some of these methods in greater detail.

### BRIEF DESCRIPTION OF THE DRAWINGS

FIG. 1. Absorption Cross Section of three spheres with radii 0.055 micron, 0.065 micron and 0.078 micron. The refractive index is 4 and its imaginary part is 0. 1, values not far from those of Silicon. The visible spectrum is from 0.4 to 0.7 micron wavelength. The spheres with radii of 0.055 and 0.065 micron have only one absorption peak in the visible spectrum, while the sphere with a radius of 0.078 micron has two such absorption peaks (resonances). The visible spectrum goes from 0.4 to 0.7 micron.

FIG. 2. The dashed line describes the Q value of the TE₁ₘ₁ (lowest mode), the solid line that of the TM₁ₘ₁ mode.

FIG. 3. Absorption Cross Section for a sphere with radius 0.04 micron, index of refraction 5, and various K values. K=0.01 solid line, K=0.1 wide dashed line, K=0.3 fine dashed line, K=1 dot dash line. The modes with a peak near 0.42-micron wavelength are of the type TE₁ₘ₁.

FIG. 4. The scattering cross section can be greatly reduced when the sphere is absorbing. Radiation trapped inside the sphere becomes absorbed rather than reemitted in a random fashion. We calculated the above example for a real index of refraction of 4 with values of the imaginary index K of 0.01, 0.1, 0.3 and 1.0. The radius of the sphere is 0.04 micron.

FIG. 5 shows both scattering and absorption together for K=0.3 and K=0.1. Absorption dominates for K=0.3 but for K=0.1 scattering is stronger than absorption in the visible spectrum (wavelengths with 0.4 micron and larger)

FIG. 6. Real and imaginary indices N and K for crystalline, amorphous and hydrogenated amorphous Silicon. The index N is represented by the curves, which are in the vicinity of 4 to 5 near 0.7 micron. The K curves are recognized by their asymptotic approach to 0 near 0.7-micron wavelength. Solid lines are for crystalline Silicon. Fine dashed lines correspond to amorphous and coarse dashed lines to hydrogenated amorphous Silicon.

FIG. 7. Absorption Cross Section for crystalline Silicon Spheres with various radii. There are curves with radii, which range from 0.035 to 0.05 micron. Even for these small radii secondary resonances are emerging.

FIG. 8. Absorption cross-sections for larger spheres of crystalline Silicon illustrating the presence of several absorption peaks in the visible spectrum. This is exacerbated by the strongly falling values of the index of refraction as the wavelength increases. Amorphous Silicon has a more constant index in the visible spectrum (FIG. 6).

FIG. 9. Absorption Cross Sections for three spheres of hydrogenated amorphous Silicon. The solid line corresponds to a sphere with a radius of 0.065 micron. The coarse and fine dashed lines correspond to sphere radii of 0.05 and 0.035 micron.

FIG. 10. Scattering Cross-Sections corresponding to the absorption data in FIG. 9.

FIG. 11. Absorption Cross-Section for Amorphous Silicon.

FIG. 12 Scattering Cross Sections for Amorphous Silicon

FIG. 13 Crystalline Silicon spheres with a radius of 0.03 μm have an optical resonance just below the edge of the visible spectrum at 0.4 μm . The result is a sharp cutoff at 0.4 μm .

FIG. 14 Crystalline Si spheres with a 0.04 μm radius have a strong absorption peak at about 0.43 μm . In transmission this results in a yellow color.

FIG. 15 Crystalline Si spheres with a radius of 0.05 μm absorb strongly in the green and also somewhat in the blue spectrum. This yields in transmission a red to magenta color.

FIG. 16. A 3D View of the Absorption Cross-Section.

FIG. 17 The diagram shows the UV protection that can be achieved with a mass loading of 3×10⁻⁵ g/cm² of cryst. Si spheres with various radii.

FIG. 18 Hydrogenated amorphous Si gives less sharp resonances because of its larger intrinsic absorption. As compared to FIG. 13 there is much more gradual transition of absorption resulting in a more yellow appearance.

FIG. 19. Hydrogenated amorphous Si spheres with a radius of 0.04 μm absorb strongly in the blue and a part of the green spectrum resulting in reddish to yellow appearance.

FIG. 20 Hydrogenated amorphous Si spheres with a radius of 0.05 μm absorb strongly in the blue and the green spectrum resulting in a red appearance.

FIG. 21. Hydrogenated amorphous Silicon powder dispersed in a transparent medium with a mass loading of 3×10⁻⁵ g/cm². The relatively stronger absorption at shorter wavelengths coupled with resonance effects gives commercially usable cutoff characteristics.

FIG. 22. Varying the mass loading of an otherwise transparent material can change the effective cutoff wavelength. Above we show absorption of hydrogenated amorphous Silicon with a fixed particle radius of 0.02 micron in concentrations ranging from 3×10⁻⁵ to 6×10⁻⁴ g/cm².

FIG. 23. We show here values of an equivalent absorption coefficient of Silicon spheres where the spheres are imagined compressed into a solid layer. All curves are for amorphous hydrogenated Silicon except for the noted example representing amorphous Silicon. Also experiments are shown for spheres, which have nominally a radius of 0.015 micron. The comparison suggests that the experimental spheres are partially hydrogenated and partly just amorphous material.

FIG. 24. We compare here the equivalent absorption coefficients for amorphous, hydrogenated and crystalline Silicon spheres. Amorphous Silicon has the highest absorption. The hydrogenated form has more transmission in the red and is therefore suitable for protective filters where some transmission is required in the red and green spectra; Crystalline Silicon has the lowest absorption in the visible spectrum.

FIG. 25. To better compare scattering and absorption we have extended here the concept of equivalent absorption coefficient, which was introduced in FIG. 23. We also show an equivalent scattering coefficient (dashed lines), which shows the total intensity reduction due to energy, scattered out of the beam. For particles with a radius of 0.04 micron scattering becomes larger than absorption beyond 0.55-micron wavelength. This does not preclude the usefulness of particles of this size since scatter may still be acceptable.

FIG. 26. Equivalent Absorption and Scattering Coefficients for particles with larger radii. For these larger particles scattering predominates over absorption at the longer wavelengths. Also scattering falls off more slowly than absorption.

FIG. 27. We show the absorption and scattering cross sections for spheres of hydrogenated amorphous Silicon with radii of 0.01 and 0.02 micron. It is clear that scattering is completely negligible relative to absorption for those particle sizes. The findings agree, of course, with those of FIG. 25.

FIG. 28. Absorption Cross Section for crystalline Si_{0.80} Ge_{0.20} alloys. Since Germanium has a much smaller band gap the absorption can be increased further out into the infrared.

FIG. 29. The real dielectric constant of three metallic Nitrides exhibiting a Froehlich Resonance. The Froehlich resonance frequency is determined by the position where the epsilon (real) curves intersect the line marked “−2 epsilon (medium)”.

FIG. 30. Real dielectric constant of Titanium Carbide.

FIG. 31. Imaginary part of the dielectric constant.

FIG. 32. Absorption Cross Sections of TiN, ZrN, and HfN for a sphere radius of 0.02 micrometer.

FIG. 33. Scattering Cross Section for Metal Nitride Particles with a Radius of 0.02 micrometer. Scattering is an order of Magnitude smaller than Absorption for the depicted Particle Size.

FIG. 34 Comparison of Extinction, Absorption and Scatter Cross-Sections for TiN, ZrN and HfN. Sphere radius is 0.02 μm. Solid lines represent Absorption, long dashed lines Extinction and short dashed lines Scattering Cross-Sections. Scattering is negligibly small.

FIG. 35 Absorption and Scatter Cross-section of Gold spheres with a radius of 0.02 μm embedded in a glass matrix. Strong green and blue absorption explains the known deep red color in old ornamental windows.

FIG. 36 The actual real Index of ZrN for bulk material (red) is compared with the Drude Free Electron Model (blue). The data are well described by a 2 femtosec relaxation time and ε(ω=∞)=6 and ωₚ=1.101×10¹⁶ sec⁻¹.

FIG. 37 The actual imaginary Index of bulk ZrN (red) is compared with the Drude Free Electron Model (blue) with various electron relaxation times.

FIG. 38. Drude free electron gas model for ZrN spheres with a radius of 0.02 μm and various electron relaxation times. The best agreement with thick film measured indices of refraction is with a 2-femtosec electron relaxation time.

FIG. 39 The nominal position of the Froehlich resonance can shift towards longer wavelengths in a Drude free electron gas as the electron scattering time shortens. The parameters are for ZrN.

FIG. 40. Absorption and Scattering for ZrN for various particle sizes.

FIG. 41 shows the absorption (solid lines) and extinction (dashed lines) cross sections of some larger spheres of ZrN. Note: The dimensions shown refer to radii as in FIG. 40.

FIG. 42. 3D Plot of Absorption Cross-Section of ZrN versus Radius and Wavelength.

FIG. 43. 3D Plot of Scatter Cross-Section for ZrN.

FIG. 44. Absorption Cross Section for TiN spheres in media with different indices of refraction.

FIG. 45 ZrN particles with a radius of 0.022 μm, uncoated and coated with 0.005 μm and 0.01 μm of TiO₂. Scattering is negligible as seen from the near coincidence of the extinction and absorption cross-sections. The index of the medium is N=1.33.

FIG. 46. ZrN spheres with a radius of 0.02 μm coated with crystalline Si films with a thickness of 0, 1, 2, 3 and 4 nm. The medium around the coated spheres is assumed to have an index of 1.33 (water).

FIG. 47. Dielectric cores of indicated diameter and an index of refraction of 1.33 coated with ZrN. The total particle diameter is 40 nm. The index of the medium is also assumed to be 1.33.

FIG. 48 Absorption and Scatter Cross-Sections of Ni spheres with a radius of 0.02 μm. The absorption is spectrally not as sharp as in ZrN.

FIG. 49 The optical constants of Nickel.

FIG. 50 The Absorption and Scattering Cross-Sections of Cr spheres with a radius of 20 nm.

FIG. 51 Optical constants and dielectric constants for Chromium metal.

FIG. 52. The resonance of Cr can be shifted into the visible by coating it with ZrN. The medium is assumed to have an index of N=1.33.

FIG. 53. Absorption and extinction cross-sections for uncoated and coated Silver spheres with a diameter of 44 nm. The coating thickness varies from zero to 10 nm as indicated. One can place in this manner an absorption line anywhere in the visible spectrum. The assumed medium is waterlike with N=1.33.

FIG. 54 Absorption (solid lines) and extinction (dashed lines) cross-sections for TiO₂ coated Silver spheres with a diameter of 40 nm. The coating thickness varies from 1 to 10 nm as indicated. The assumed medium is waterlike with N=1.33.

FIG. 55 Plot of the absorption and extinction cross sections of 40 nm diameter Silver shells over a dielectric core (Ncore=1.33) of various diameters.

FIG. 56 For comparison we show here the same Silver coated nanoparticles except that the core has now an assumed index of refraction of N=2. The Figure illustrates a trend that the red shift increases with the index of refraction of the core. Also the absorption cross sections decrease with an increasing index of the core.

FIG. 57 In this diagram the nanoparticles are identical to those in FIG. 55 and FIG. 56 except the core has now an index of refraction of N=3.

FIG. 58 A coated nanoparticle with a dielectric core (N=1.33) and a Silver shell is uniformly scaled to illustrate the effect of overall particle size on absorption and scattering cross-sections.

FIG. 59 Magnesium Spheres coated with a thin layer of crystalline Si give absorption peaks in the visible spectrum. The light dashed lines represent extinction.

FIG. 60 A dielectric core with N=1.33 coated with Mg for a total particle diameter of 40 nm. Higher cross sections in comparison to result when a dielectric core is coated with Mg. rather than an Mg core being coated with a high dielectric constant material.

FIG. 61. Aluminum Spheres coated with layers of crystalline Si give absorption peaks in the near ultra-violet and visible spectrum. The light dashed lines represent extinction.

FIG. 62. Al spheres coated with a layer of TiO₂, as indicated. Because of the slightly smaller index of TiO₂ in comparison to Si, absorption cross-section peaks are shifted less for equal coating thickness when compared to the example depicted in FIG. 61. Aluminum Spheres coated with layers of crystalline Si give absorption peaks in the near ultra-violet and visible spectrum. The light dashed lines represent extinction.

FIG. 63 Dielectric cores coated with Aluminum.

FIG. 64. TiO₂ cores coated with aluminum. A larger red shift is obtained in comparison to a lower index core but the cross-sections are smaller for cores with a larger index.

FIG. 65. ZrN is applied as a shell on a dielectric Core. Tho outer shell diameter is 40 nm. The core diameter is varied and its diameter is indicated on each curve. Solid lines are absorption cross sections while dashed lines are extinction cross-sections. (N_{med}=1.33) FIG. 66. Glass cores of 15 and 25 nm diameters coated with 2 and 6 nm of ZrN.

FIG. 67. Illustration of the increasing red shift and decreasing absorption cross-section with increasing core dielectric constant. The example is for a 37 nm core with a 3 nm thick Al coat.

FIG. 68. 36 nm Al spheres with thinner TiO₂ coatings of up to about 5 nm in thickness provide uv protection without objectionable absorption in the visible spectrum.

FIG. 69. Aluminum spheres with a diameter of 36 nm covered by Aluminum oxide of different thickness. UV protection can be obtained through these relatively simple nanoparticles.

FIG. 70 UV protection from 36 nm Al spheres coated with 3 and 4 nm Ag layers.

FIG. 71. UV protection from a dielectric core (N=1.33) coated with Aluminum or Aluminum and Silver.

FIG. 72. Mg spheres with radius 0f 22 nm coated with the more absorbing Hydrogenated Amorphous Silicon (layer thickness as indicated).

FIG. 73 Al metal core coated with a “thick” ZrN layer shifts the ZrN absorption resonance to shorter wavelengths.

FIG. 74 Hypothetical ZrN sphere with R=22 nm coated with 1 and 2 nm of Al metal and also uncoated.

FIG. 75 Hypothetical TiN sphere with R=22 nm coated with 1 and 2 nm of Al metal and also uncoated.

FIG. 76. Cu when uncoated has a very broad absorption band not typical of the regular Froehlich resonance. Coating it with a high index film (Si) shifts the resonance to the red and beyond and sharpens up the peak.

FIG. 77. 40 nm diameter Copper spheres with a dielectric core of index N=1.33. Coating Thickness is indicated.

FIG. 78. 40 nm diameter TiN spheres coated with cryst. Silicon of indicated thickness. The absorption peak can be shifted well into the infrared spectrum.

FIG. 79. We show here an interesting interaction of a pure Si resonance near 0.35 μm and a Plasmon resonance from ZrN. The resulting resonance lies in between the two “pure” resonances. There is also red shifted plasmon resonance beyond the 0.8 μm limit of the graph.

FIG. 80 We are depicting an Aluminum nanosphere of 40 nm diameter. Inside the sphere we have an enclosed shell of a dielectric medium (N=1.33) of a thickness of 4 μm. The position of this shell is varied from near the outer edge of the particle to a more inside position.

FIG. 81. This is a variation of FIG. 80 with an Al core followed by a dielectric layer (N=1.33), followed in turn by an Al outer shell. Here we vary the dielectric shell thickness while leaving the outer Al shell unchanged.

FIG. 82 Example of a more complicated three layer composite particle consisting of a dielectric and a segment of Silver and of Aluminum.

FIG. 83. Three layered particles (40 nm diameter) with Al as core and a dielectric (N=1.33) as a middle layer and a 3 nm thick Ag shell. The diameter of the core is varied from 2 to 30 nm.

FIG. 84. Three layered particles analogous to FIG. 83 except Silver is replaced by Magnesium

FIG. 85 This diagram is identical to FIG. 83 except the role of the Al and Ag layers is interchanged.

FIG. 86 Another three layer composite particle consisting of a dielectric and a segment of ZrN and of Aluminum.

FIG. 87. We illustrate how the Al plasmon resonance, normally near 0.2 μm, can be shifted first by a dielectric core of 34 nm diameter (N=1.33) to the edge of the visible spectrum and then shifted further into the visible spectrum by an outside coating of TiO₂ from 1 to 5 nm. The example applies to a 3 nm thick Al inner shell.

FIG. 88: Actual absorption of 2×10⁻⁵ g/cm² of ZrN nanopowder as a function of particle size. Smaller particles give the better results. They also do not scatter and extinction and absorption become nearly the same. The color effect of ZrN nanopowders is expected to be magenta like.

FIG. 89: Transmission of 2×10⁻⁵ g of TiN per cm² due to absorption and scatter. For particle sizes of R=0.01 micrometer there is no difference between extinction and absorption.

FIG. 90 We show in the case of ZrN that indeed the relative absorption cross-section starts to increase with radius r. The cross-section then exhibits a peak and subsequently declines. The wavelength was chosen to be 0.52 μm to correspond to the peak of the cross section—(at least for the small and medium sized particles).

FIG. 91 shows the absorption coefficient of 1 g of TiN spheres suspended in 1 cm³ of solution with an index of N=1.33. Obviously small particles give the best absorption and below a critical radius of about 0.025 micrometer it does not matter how small the particles are. The present Figure makes same point as FIG. 89 for TiN and FIG. 92 below for ZrN.

FIG. 92: Transmission for 2×10−5 g/cm2 of ZrN. As in the case of TiN the absorption for R=0.01 and R=0.03 is virtually the same. However the smaller radius particle shows no scatter and transmission curves from absorption and extinction (I. e. absorption plus scatter) are practically identical.

FIG. 93: Extinction curves for 2×10−5 g/cm2 of ZrN. For small particles there is hardly a change from absorption to extinction. For the larger particles there is a big difference. Compare with FIG. 92.

FIG. 94: Transmission curves due to absorption for an area loading of 2×10⁻⁵ g/cm² of HfN. Because of the large atomic weight of HfN there are fewer atoms in a given mass loading and from this consideration alone one can understand the relatively lower absorption values. HfN Nan particles are expected to give an orange color.

FIG. 95: Transmission due to extinction for a mass loading of 2×10⁻⁵ g/cm² of HfN.

FIG. 96. The Illustration for the case of ZrN with ε_{medium}=1.33. We show how the Froehlich resonance shifts as a sphere is deformed into an ellipsoid. The resonance frequency breaks into two resonances, where one is excited by a light electric field vector along the major axis and the other one by a field vector along a minor (shorter) axis. We consider both the case of a prolate ellipsoid (cigar shape) and an oblate ellipsoid (pancake shape).

FIG. 97. The four F functions needed to calculate the resonance frequency for any material with different dielectric constants.

FIG. 98. Absorption coefficient of Ga₁₋ₓInₓ N system as a function of x. The leftmost thin solid line corresponds to pure GaN with x=0. The double dot dashed line is for x=0.25. The dot dash line corresponds to x=0.5, the fine dotted line to x=0.75 the coarse dashed line is for x=0.9, and the heavy solid line is for pure InN with x=1.

FIG. 99 estimates the protection that would be obtained by putting a thin layer of InN on a transparent substrate. The layer thickness is indicated. To obtain the mass loading per cm² one needs to multiply the above numbers with the specific weight of InN. This is the material with the deepest red cutoff wavelength.

FIG. 100 is analogous to FIG. 99 except the composition of the alloy is only 50% In with 50% Ga. The cutoff now lies in the blue spectrum. Yet lower In concentrations will shift the absorption further towards the ultraviolet spectrum.

FIG. 101. This figure shows the transmission of light upon perpendicular incidence through films of crystalline Silicon with various thicknesses. It is also compared to data from an experimental film on Polyester. Here the multiple reflections are fully taken into account.

FIG. 102. Transmission through hydrogenated amorphous Silicon showing interference effects from multiple reflections.

### COLOR BY RESONANCE ENTRAPMENT OF RADIATION IN NONMETALLIC DIELECTRIC SPHERES

It is well known from microwave technology that good cavities can be made from a high dielectric material alone, without any metallic walls. Radiation can be trapped by total or near total reflection from dielectric—air boundaries (R. E. Collins, Field Theory of Guided Waves, IEEE Press, Piscataway, N.J., 1991, p461). The lowest modes in a sphere are known as the TE₁ₘ₁ and TM₁ₘ₁ resonances. From perturbation theory one can calculate the approximate resonance wavelengths. For the TE₁ₘ₁ mode one obtains

$$λ = \frac{2 nr}{1 - \frac{1}{{n}^{2} + jn π}}$$

Similarly the expression for the TM₁ₘ₁ mode becomes

$$λ = \frac{2 π nr}{{x}_{0} - \frac{{nx}_{0} + {jx}_{0}^{2}}{( {n}^{3} + 2 n - {nx}_{0}^{2} ) + j ( {n}^{2} {x}_{0} + 3 {x}_{0} )}}$$

with x₀=4.4934.

In the above expressions λ is the vacuum wavelength for resonance, n is the index of refraction of the sphere, r is the sphere radius, and j=\sqrt{(−1)}.

In the approximation of large n we can calculate the ratios of the wavelengths of the two lowest order modes

$$\frac{{λ}_{TE}}{{λ}_{TM}} = \frac{{x}_{0}}{π} ≅ 1.43$$

Summarizing and adding the third lowest mode to the above discussed two modes one finds, in the approximation of large n
λ₁=2nr
λ₂=1.4nr
λ₃=1.12nr

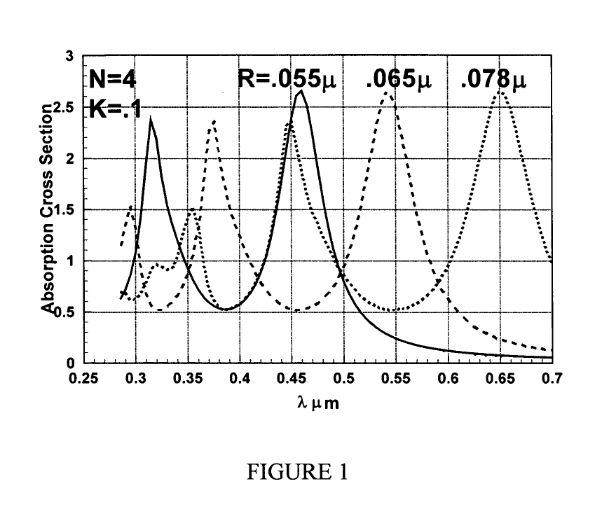

Thus when the TM mode just enters the visible spectrum at 0.4 micron then the TE mode lies at 0.572 micron, which is near the transition from the green to the red portion of the spectrum. Thus if n is constant and independent upon wavelength then one can have only one absorption line anywhere in the spectrum between 0.4 and 0.572 micron. As the radius of the sphere becomes larger the TE₁ₘ₁ moves further into the red and another mode (TM₁ₘ₁) moves into the blue and we have two absorptions in the visible spectrum, one of which lies in the red somewhere beyond 0.572 micron. This is one of the limiting factors that has to be kept in mind when considering resonance colors, based on resonance entrapment: There are restrictions if one wants only one absorption line, especially if this line is near or in the red spectrum. We are illustrating this in FIG. 1 through a detailed calculation using exact computer solutions where we show the absorption cross sections of three spheres with different radii. The index of the material was chosen to be 4. The material has to be at least weakly absorbing or otherwise, even in the presence of resonances, there could not be any absorption. We thus choose a complex index of refraction with an imaginary part of 0.1. These index values are not far from those of crystalline Silicon. A complex index implies absorption losses in the material. In fact the imaginary part of the index K can be simply related to the energy absorption coefficient α by the equation

$$α = \frac{4 π}{λ} K$$

where λ is the vacuum wavelength of the radiation. The intensity I of the radiation is attenuated in bulk material according to the customary expression
I=I₀ exp(−αx)

We can, however, under favorable conditions have a situation where only one absorption line occurs in the red, namely when the index of refraction is dependent upon wavelength and is larger in the red portion of the spectrum. What really counts is the value of nλ rather than wavelength alone. If the index n increases by 22% in the range from 0.4 to 0.7 micron then only one absorption peak will occur in the visible even if this absorption lies near 0.7 micron, which is the edge of the red visible spectrum. We shall see later that it is relatively more straightforward to have a red only absorption by the Froehlich resonance. Thus we need not excessively worry about red only absorption (blue color in transparency) through resonance spheres. We can in principle make all colors by using both physical resonances, but in different materials.

A strong and well-confined resonance requires a situation where the quality factor Q of the cavity is reasonably good. The half width of a resonance is Δλ=λ/Q. Thus a Q of 10 for a resonance at 0.5 micron gives a half width of the resonance of the absorption of 0.05 micron. The losses due to radiation leakage alone depend upon n. A complex index causes additional losses through absorption in the spherical dielectric resonator thus broadening the resonance further. Using the above formulas one can calculate Q as a function of the dielectric discontinuity at the surface of the dielectric sphere, assuming that the absorption losses are much smaller than losses through radiation leakage. Q is defined as

$$Q = \frac{{ω}_{0} Energy ( stored )}{Energy ( dissipated \text{-} in \text{-} unit \text{-} time )} \\ = \frac{π Energy ( stored )}{Energy ( lost \text{-} per \text{-} half \text{-} cycle )}$$

Thus Q is related to how many times radiation bounces around inside a loss less sphere before exiting. Formally

$$Q = \frac{Re ( 1 / λ )}{2 Im ( 1 / λ )}$$

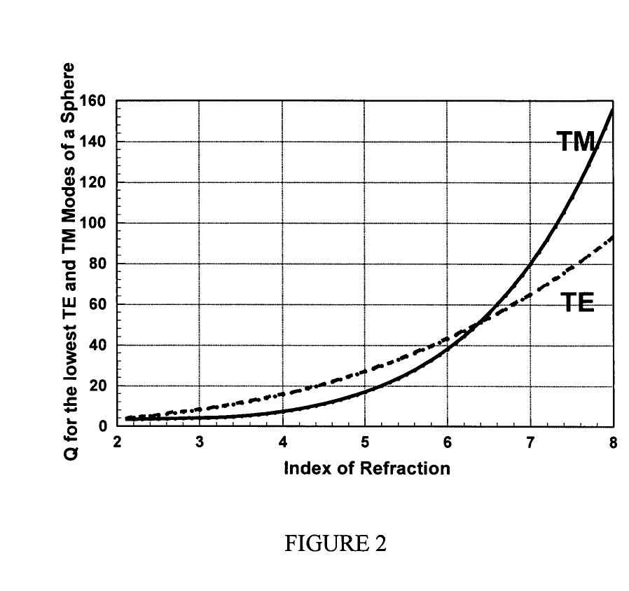

In FIG. 2 we plot Q for the two lowest modes as a function of the index, or more correctly, as a function of n (dielectric)/n (medium). The calculations are based on an exact algorithm and do not use the above quoted approximate formulas.

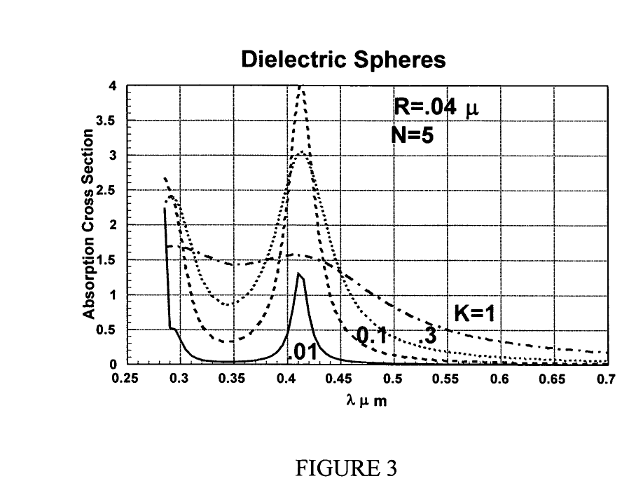

It is seen that one requires values for n that lie in the range of 4 and higher to give the desired half widths. Indices of such value are very uncommon in transparent materials. Diamond has an n value of about 2.4. We also need materials with some absorption. It turns out that the imaginary value of the index should be somewhere in the range of about 0.01 to perhaps 0.4. In FIG. 3 we show absorption cross sections for an index of 5 for several values of K, the imaginary index of absorption. It shows that a near optimum value for the imaginary part of the index of refraction K is in the neighborhood of 0.1. Larger values broaden out the line and for K=1.0 the resonance structure is totally washed out.

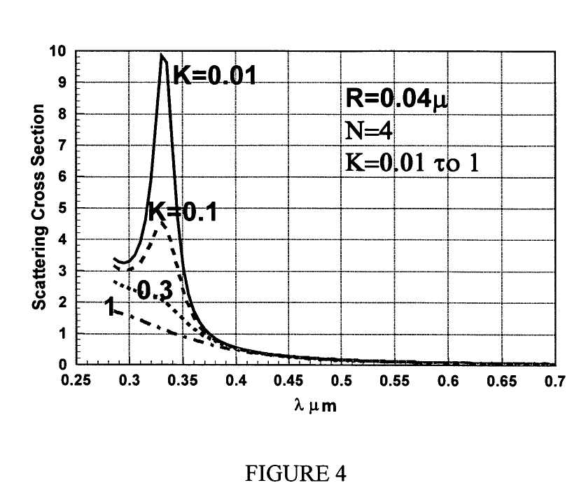

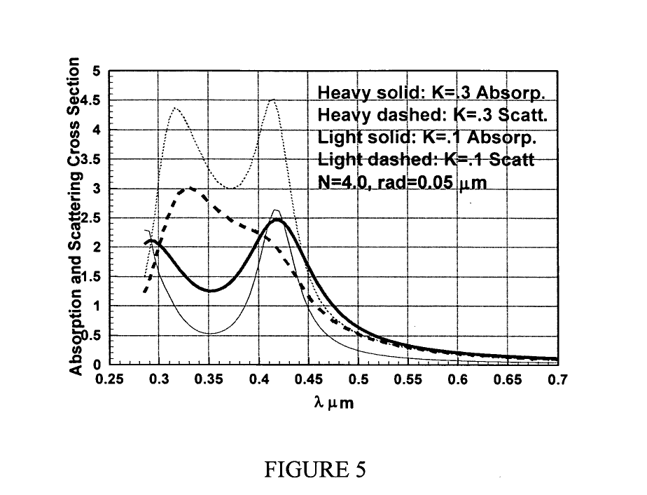

Desirable materials, which show indices of refraction as well as K values in the right range of values, include common semiconductor materials such as Silicon, Germanium and Silicon Germanium alloys and other indirect semiconductors. Metals are unsuited under normal situations because their large absorptions preclude resonances with reasonable quality factors. So called indirect semiconductors have their conduction band minima and their valence band maxima at different positions in the Brillouin zone, i.e. not both at the same propagation vector value k=0 (propagation vector k should not be confused with the imaginary optical index K). Optical transitions are forbidden to the lowest order in semiconductors with indirect band gaps. In this way moderate absorptions are achieved with K values below 1 and pronounced resonance effects can occur. At the same time these materials have indices of refraction, which are in the range of about 4 to 6 in the visible spectrum. Amorphous materials of Silicon are also of great interest because the disallowed transitions become gradually allowed as the crystal symmetry is disturbed. A fine-tuning of the absorption effects can in this way be accomplished. Choosing the right value of absorption is also important because on the one hand it increases the absorption while on the other hand it reduces the scatter. The reduction of scatter with increasing absorption near resonance is a very important concept for color pigments. The effect is illustrated in FIG. 4 where a sphere radius of 0.04 micron is assumed. The real index of refraction is 4 (Silicon like) and K is varied from 0.01 to 1.

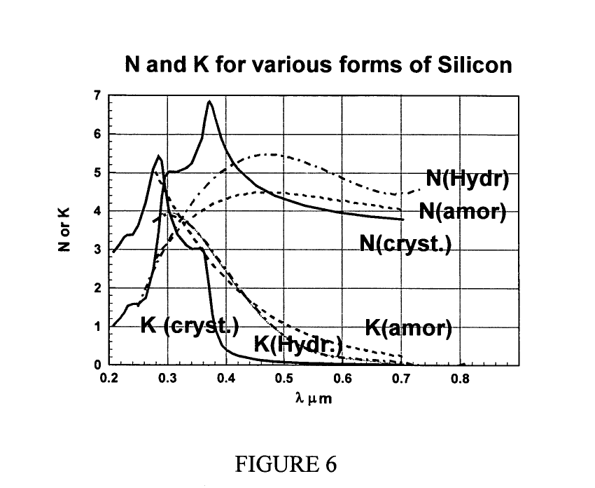

In FIG. 6 we show the optical constants N and K of Silicon, amorphous Silicon and hydrogenated amorphous Silicon. The real portion of the index of refraction decreases in Silicon as we move from the blue to the red portion of the spectrum. This pushes the resonances closer together and more than one resonance tends to exist in the visible spectrum, especially for crystalline Silicon.

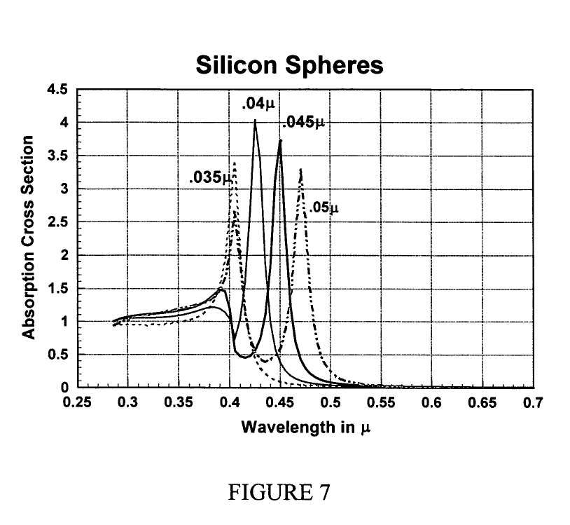

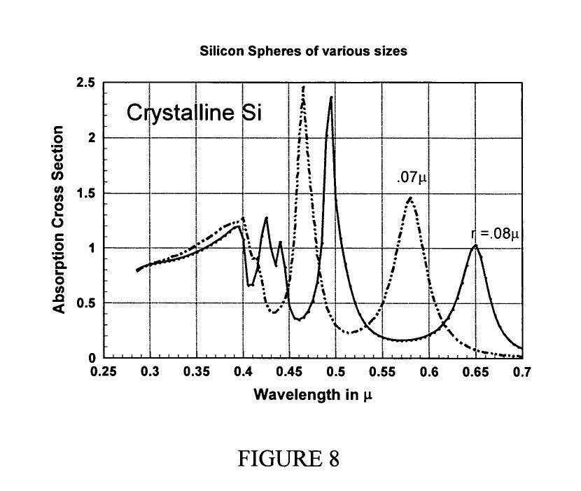

In FIG. 7 we show Absorption Cross Section for crystalline Silicon spheres with various radii.

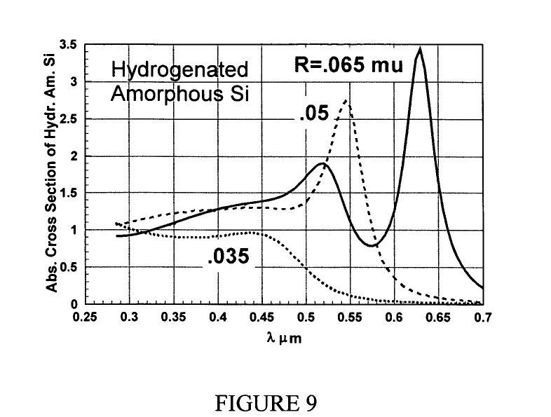

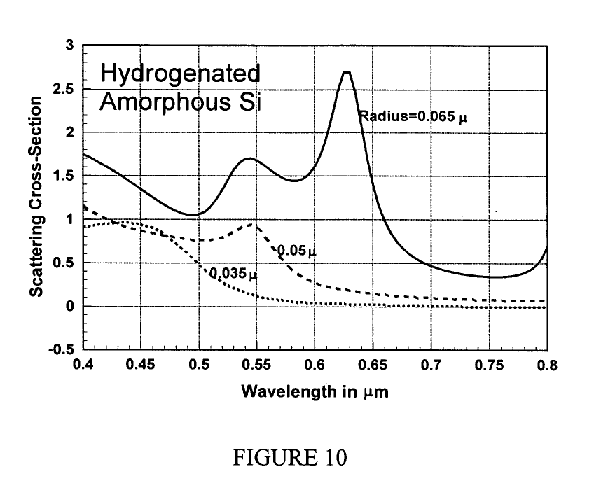

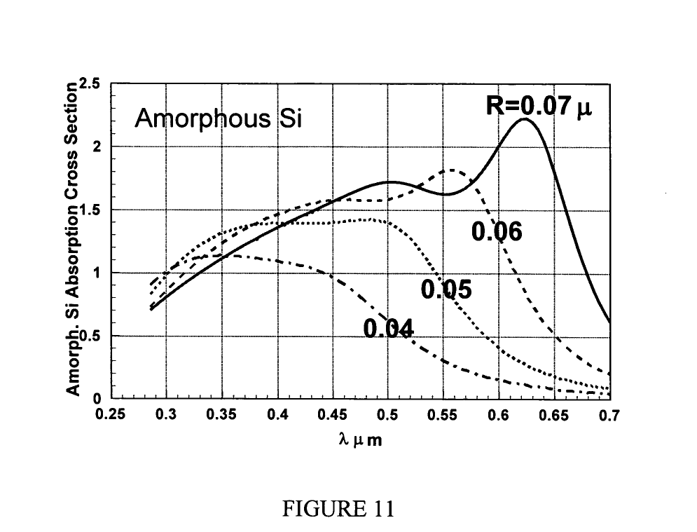

The absorption cross-sections in the infrared become smaller because the intrinsic crystalline Silicon absorption or K values become lower. In general more than one resonance is found in the visible spectrum, because the real index strongly decreases with increasing wavelength. In the green and red portions of the spectrum hydrogenated amorphous Silicon and even more so pure amorphous Silicon have much higher absorption. The effects upon the absorption cross-sections for hydrogenated amorphous Silicon is illustrated in FIG. 9.

Excellent red absorption is achieved with a sphere radius of 0.065 micron. There is then also a second much weaker peak at a wavelength of 0.52 micron in the green. The 0.05-micron spheres absorb strongly in the green and much weaker the blue spectrum. The 0.035-micron spheres absorb the blue spectrum alone.

Below we show in absorption cross sections of spheres made from even more strongly absorbing amorphous Silicon. Here resonances are washed out but natural absorption is increased through resonance effects giving rise to transmission windows in the red spectrum.

The sphere radii are: Solid line r=0.07, coarse dashed line r=0.06, fine dashed line r=0.05 and dot dashed line r=0.04 micron. The resonances are washed out because of heavy absorption. However the absorption effect can be used for absorbing light at shorter wavelengths, allowing transmission in the red spectrum, depending on the sphere radius.

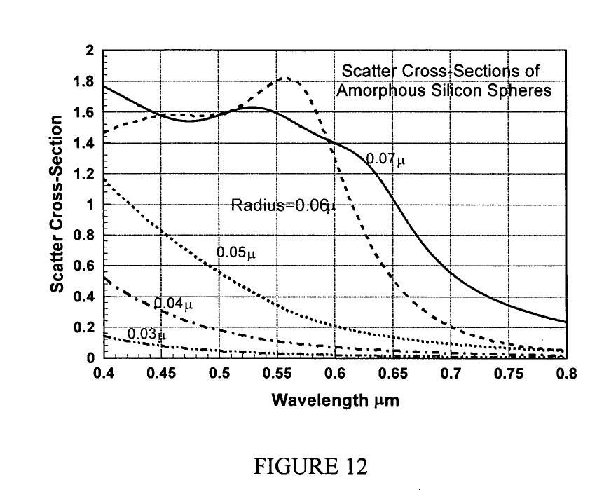

The corresponding scatter Cross-Sections are shown in FIG. 12. Scattering is small for radii of 0.05 μm and smaller.

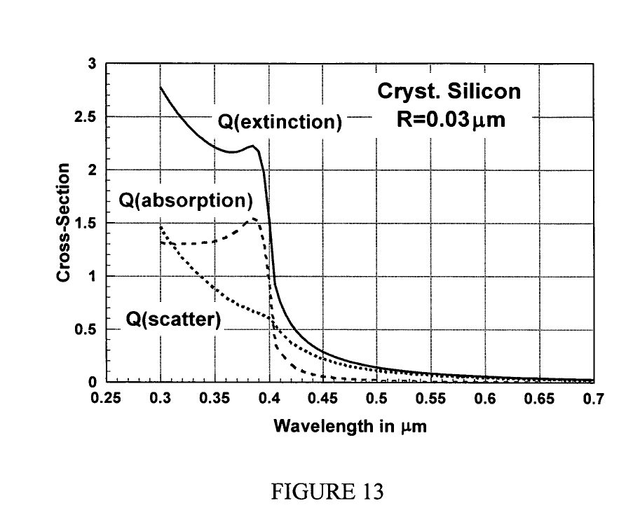

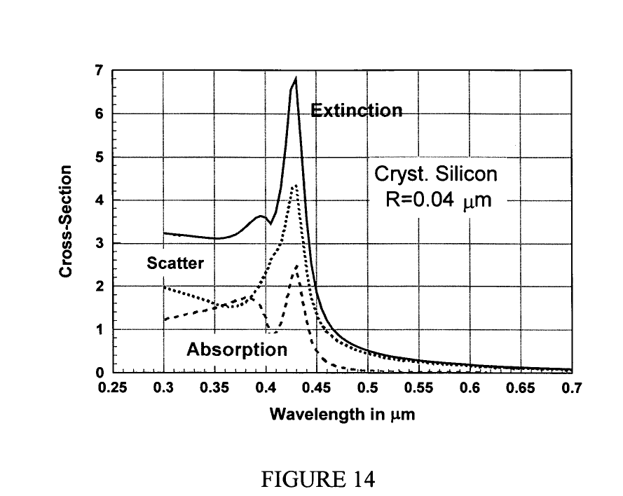

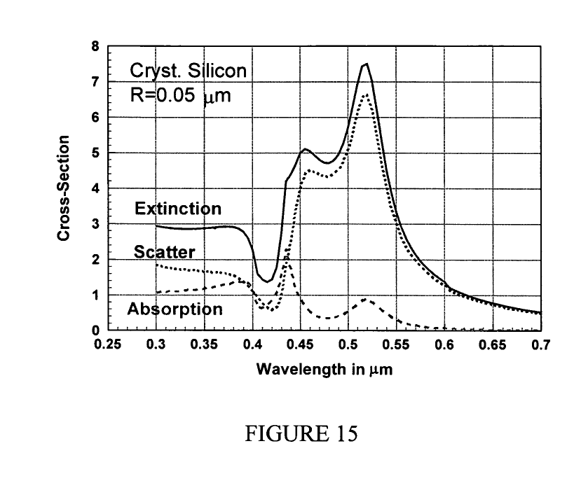

To illustrate the Si sphere properties further we summarize in the following some of the above presented material in a different form. We show extinction, absorption and scattering cross-sections in the same Figure for different sphere radii and different crystal phases of Silicon. Please note that the sum of the scattering and absorption cross-section is referred to as the extinction cross-section. Sharp ultraviolet cut-off characteristics can be achieved with crystalline Silicon, as illustrated in FIG. 13. The cut-off characteristics can be fine tuned with slight modifications in the particle radius. Changing the particle size can lead in transmission from yellow to magenta and red colors, as depicted in FIG. 13 to FIG. 15.

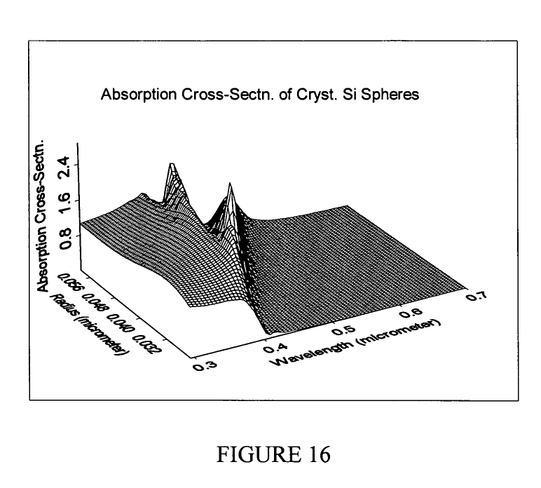

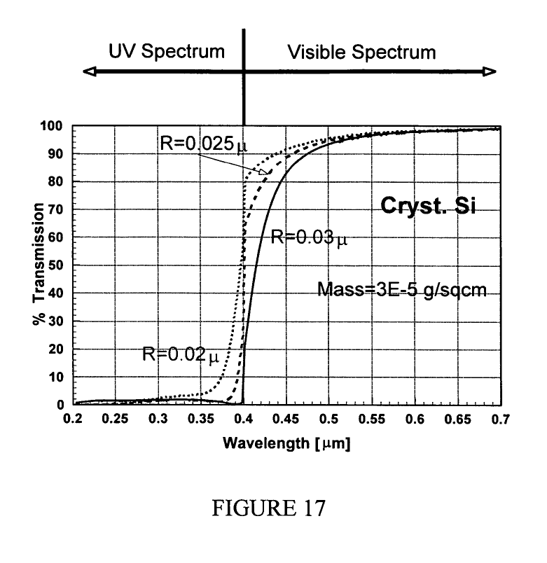

By using spheres of the proper diameter the absorption cut-off can be placed directly at the edge of the visible spectrum at 0.4 μm (see FIG. 16 and FIG. 17). For a clean yellow color slightly larger spheres can be used. The visual appearance of the color shifts with particle size.

To calculate the absorption we start from the above-calculated cross-sections. Let us assume that we disperse a powder with a given weight into a medium with a volume of 1 cm³. The actual volume of the silicon spheres is W/ρ, where ρ is the density of Si (2.33 g/cm³). In a slice of thickness dx and a cross-section of 1 cm² we have a volume of Si of(W/ρ)dx. We can calculate the number of spheres in that slice by dividing by the volume 4πr³/3 of one sphere. The geometric cross-section of these spheres is obtained by multiplication with the cross-section πr² of one sphere. The amount of radiation that is absorbed by these spheres is equal to their total geometric cross-section multiplied by the above calculated absorption cross section Q. Thus if we call I the intensity of the incident radiation then this intensity will diminish by dI in the distance dx as shown

$$dI = - I ( \frac{3 WQ}{4 ρ r} ) dx = - I α dx$$

In a distance d the intensity will have fallen to

$$I = {I}_{0} exp - ( \frac{3 WdQ}{4 ρ r} )$$

The absorbed amount of radiation is related to Wd and thus depends only on the total weight/cm² that the radiation traversed. We shall refer in this paper to Wd as the mass loading per cm2 of the nanopowder. The calculation is approximate because scattering can increase the distance the light travels in the loaded medium. The actual absorption may therefore be somewhat larger.

The FIG. 17 above shows the UV protection that can be achieved with 3×10⁻⁵ g/cm² of cryst. Si spheres. The transmission cut-off can be tailored by the choice of particle size. We show particle radii of 0.03, 0.025, and 0,02 μm .

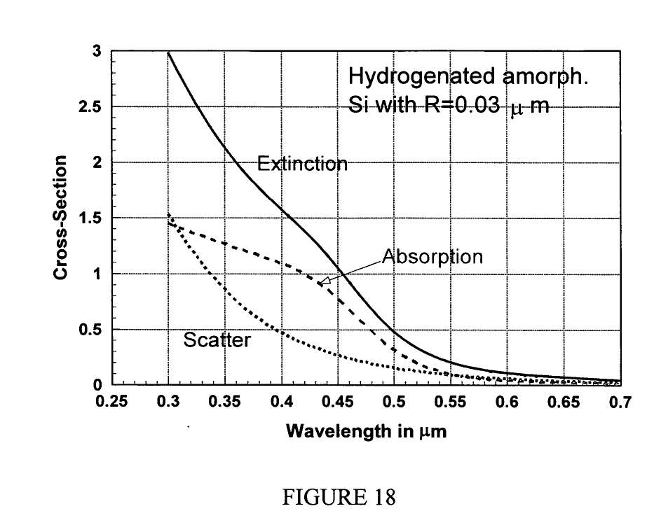

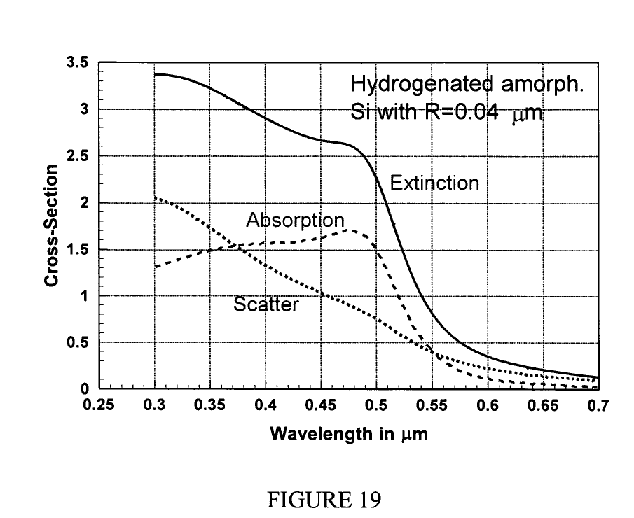

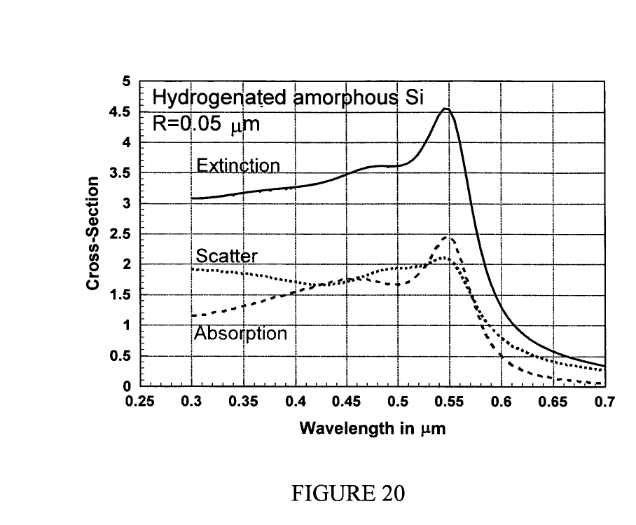

Hydrogenated Silicon has a larger intrinsic absorption and thus the Q of the resonance and its spectral sharpness is markedly decreased. This is illustrated in FIG. 18 to FIG. 20. Generally speaking, one sees a more gradual transition from absorption to transmission. Sharp UV cut-off characteristics are not achieved, as seen in FIG. 18.

The above discussed absorption characteristics can be used to transmit wavelengths, which are longer than a certain cutoff wavelength, but to absorb the shorter more energetic radiation to protect, for example, the skin or other organic or biological substances.

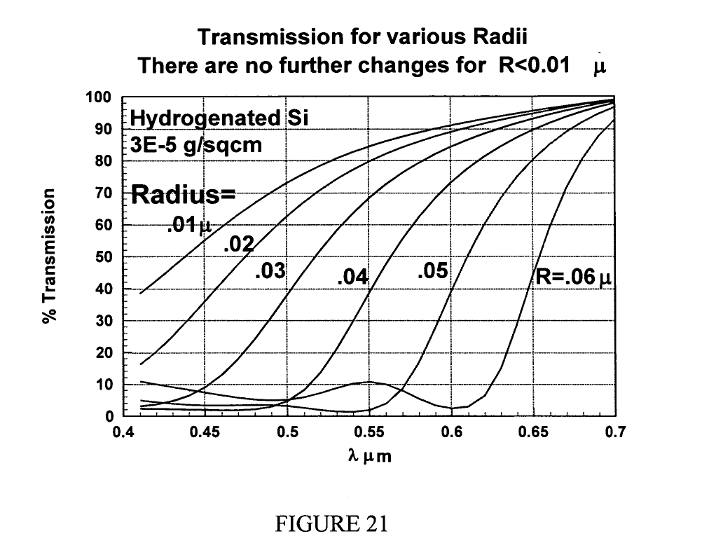

As an illustration of an application we show in FIG. 21 powder made from hydrogenated amorphous Silicon dispersed in a transparent medium with a Silicon mass loading of 3×10⁻⁵ g/cm² . A slightly better cutoff can be obtained by increasing the mass loading to about 5×10⁻⁵ g/cm².

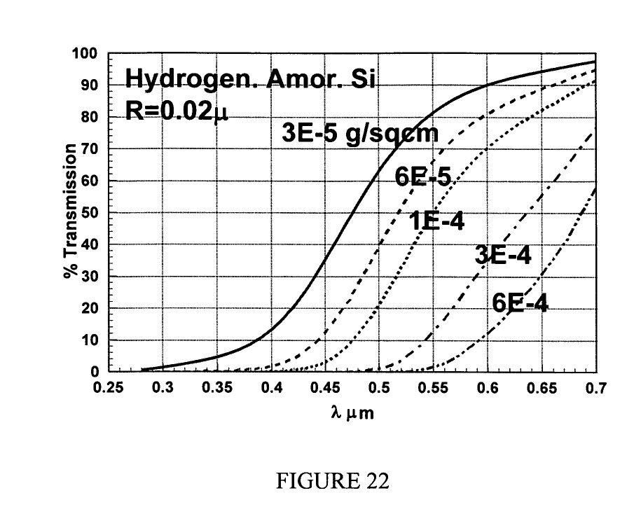

One can also vary the position of cutoff in otherwise transparent media by changing the concentration of Silicon spheres with a given radius. This ability to change the absorption edge results from the gradual decrease with wavelength of the absorption characteristics of colloidal Silicon suspensions. Increasing the concentration shifts the cutoff wavelength further into the red. This is shown in FIG. 22.

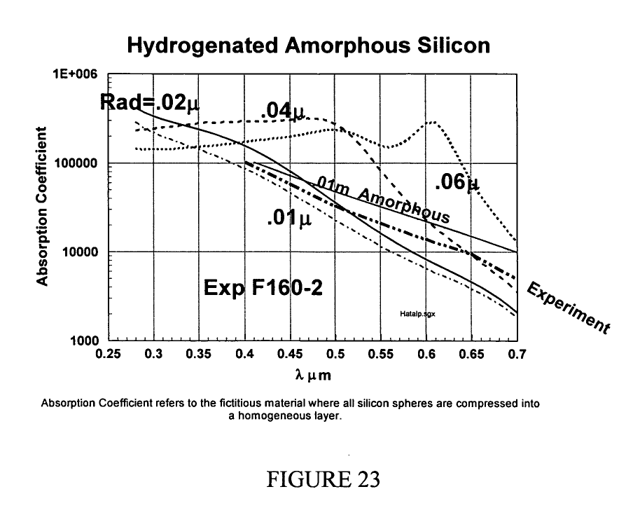

In FIG. 23 we show an equivalent absorption coefficient for Silicon spheres. This equivalent absorption coefficient α of dimension [1/cm] refers to a fictitious material where all the silicon spheres in the suspension are thought to be compressed into a homogeneous Si layer, but the optical absorption is still thought to be the same when the material was dispersed. This equivalent absorption coefficient can be calculated from the equation

$$α = \frac{1}{L} \frac{100}{W \%} \frac{{ρ}_{Si}}{{ρ}_{polimer}} ln ( \frac{{I}_{0}}{{I}_{trans}} )$$

where L is the actual length of the loaded sample, W % is the weight percentage of the Si spheres in the host material (usually a polymer), ρ_{Si} and ρ_{polymer} are the specific weights of Si (=2.33) and polymer (about 1), resp., I₀ and Iₜᵣₐₙₛ are the intensities of the incident and transmitted beams after correction for reflection losses at the respective air/polymer and polymer/air interfaces. The reflection coefficient for such an interface is

$$R = {( \frac{{n}_{1} - {n}_{2}}{{n}_{1} + {n}_{2}} )}^{2}$$

where the n's refer to the indices of refraction for the two materials on either side of the interface.

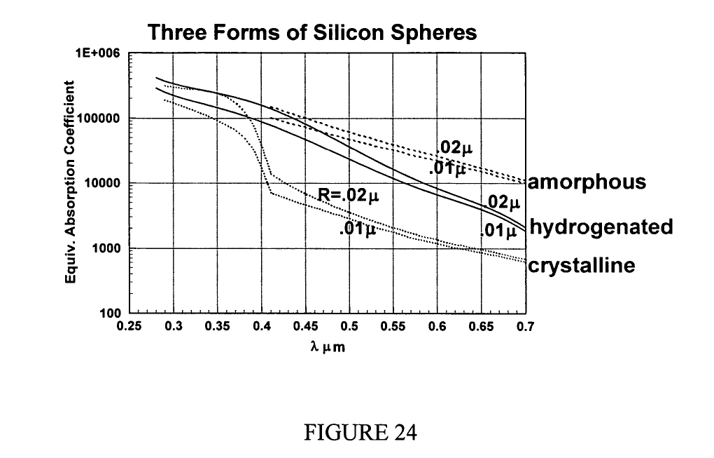

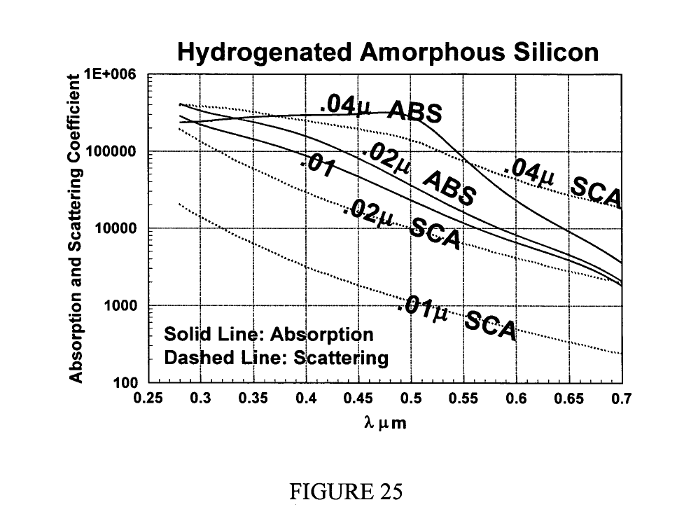

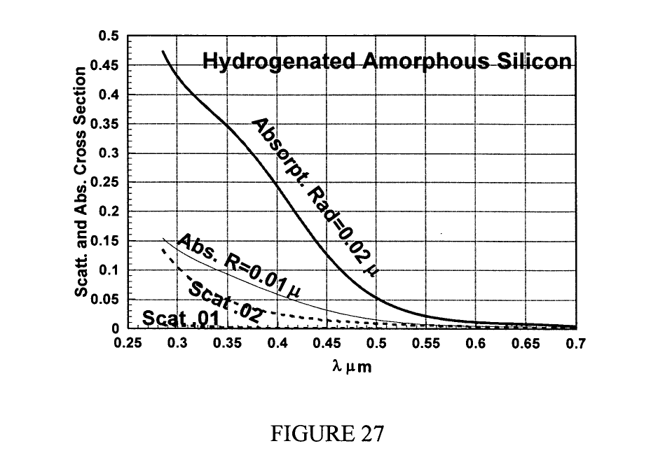

The calculations are compared to experiments in which Silicon powder is suspended in an alcohol suspension. There is good agreement if we assume that the amorphous Silicon is only partially hydrogenated. The powder was prepared by Prof. John Haggerty at MIT in Cambridge, Mass. by a method in which SiH₄ gas entering into a reduced pressure Chamber through a nozzle is decomposed by a CO₂ laser. For an indicated particle size of 0.015 micron scattering should be negligible, as illustrated further below in FIG. 25 and FIG. 27. In FIG. 24 we show for comparison the equivalent absorption coefficients for the three forms of Silicon.

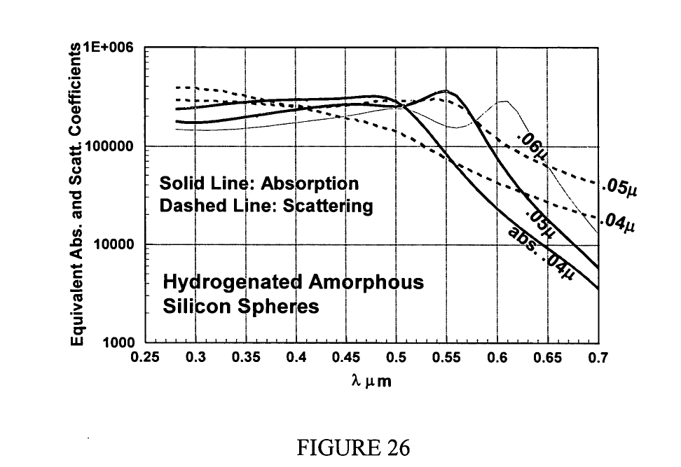

For larger particles scattering becomes dominant especially in the longer wavelengths region. The scattering also falls off more slowly with wavelength than absorption. This is illustrated in FIG. 26 below.

We conclude that one can achieve clear transparent materials except for the desired cutoff characteristics as is illustrated in FIG. 25 and FIG. 27, provided the particle size does not become too large as illustrated in FIG. 26.

Below we show absorption cross sections for Silicon-Germanium alloys. The addition of Germanium increases the absorption or K values in the red portion of the spectrum similar to the amorphous phases of Silicon. Greater Germanium mole fractions would further enhance the red absorption. Thus alloying is another mechanism for optimizing K values and absorption.

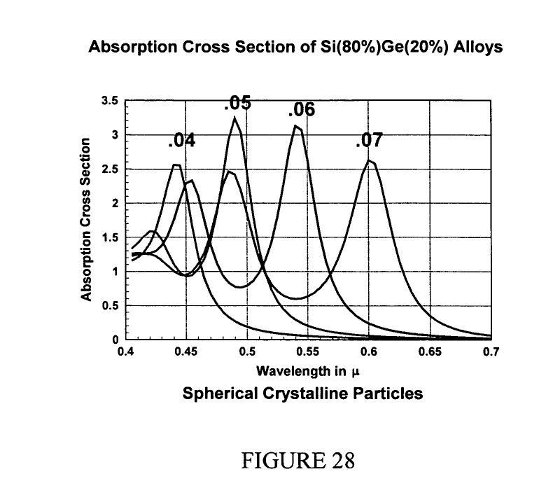

Germanium Silicon alloys (FIG. 28) can likewise be used in situations where amorphous Silicon or its hydrogenated forms are applicable. The narrower band gap of Germanium increases the absorption in the red portion of the spectrum. Higher concentrations of Germanium give rise to an even larger absorption.

Metal Pigment Absorption by Froehlich Resonance

Before starting our discussions we want to point out that the metallic resonance by free electrons goes under both the name of Froehlich and Plasmon resonance. We shall now consider highly conducting metallic spheres. Metals have very different properties than pigments or resonant high dielectric constant spheres. The index of refraction usually has only a small real part indicating low or no trapping of radiation inside the sphere and any radiation trapped there would get absorbed very rapidly so that bulk resonance modes would hardly be expected. Nevertheless the recently observed blue color exhibited by metallic TiN spheres is of considerable interest. In the long distant past colloidal gold particles were empirically used to color ornamental glass windows with a deep red color. The observed TiN colors are based on similar physical principles. As we shall show similar colors are expected from ZrN, HfN and their alloys with TiN. There has been only limited experimental work done. The calculations below are expected to be exact, provided we can make spheres with the same optical constants of the materials as they have been measured on bulk pieces or on thin films. We give in the following a short general explanation of the effect. It should not be confused with resonance trapping of radiation by high dielectric constant spheres, such as silicon or TiO₂ . Our previously developed computer program of the Mie theory can again be used to quantitatively predict the optical behavior.

The peculiar property which is here of central importance is the fact that in many metals the real part of the dielectric constant is negative for optical frequencies. Drude has explained the origin of this effect: Free conduction electrons in a high frequency electric field exhibit an oscillatory motion. For unbound electrons the electron motion is 180 degrees out of phase with the field. This phenomenon is well known in all driven resonators, even simple mechanical ones. Consider the equation of motion for an unbound electron in an ac field.

$$m \frac{{ⅆ}^{2} x}{ⅆ {t}^{2}} = qE cos ( ω t )$$

In the above equation m is the electron mass, x is the coordinate along the oscillating electric field, q is the electronic charge and E is the amplitude of the electric field vector, and t is the time. The solution, except for integration constants, is

$$x = - \frac{qE}{m {ω}^{2}} cos ( ω t )$$

It illustrates the statement that field and electron position are indeed 180 degrees phase out of phase with respect to each other. The weakly bound or unbound electrons in a so-called free electron metal act basically in the same way. Electronic polarization by free electrons is therefore negative. Since in elementary electrostatics it is shown that the polarization is proportional to ε-1, it follows that ε has to be smaller than one and it may in fact even be negative. In tables of optical constants of metals one finds usually tabulated the real and imaginary parts of the index of refraction, N and K, as a function of wavelength. The dielectric constant is the square of the index of refraction, or
εᵣₑₐₗ+jε_{imag}=(N+jK)²=N²−K²+2jNK
or
εᵣₑₐₗ=N²‘K²
ε_{imag}=2NK
And thus it may be seen that εᵣₑₐₗ is negative when K is larger than N. A look at the above-alluded tables reveals that indeed this condition is satisfied for a number of metals and metallic compounds.

In electrostatics one usually finds in most textbooks derivations for the magnitude of the electric field inside a dielectric sphere, which is immersed in a constant surrounding field. In cases where the wavelength is much larger than the sphere radius the metal sphere is surrounded by an electric field, which is approximately constant over the dimensions of the sphere, and thus the electrostatic approximation becomes appropriate for estimating the magnitude of the field inside of the sphere. From electrostatics we obtain

$${E}_{inside} = {E}_{outside} \frac{3 {ɛ}_{outside}}{2 {ɛ}_{outside} + {ɛ}_{inside}}$$

where E_{outside} is the surrounding field, E_{inside} is the field inside the sphere and ε_{inside} and ε_{outside} are the (real) relative dielectric constants inside the sphere and in the surrounding medium, resp. From the above equation it becomes immediately obvious that the field inside the sphere would become infinitely large if the condition
2ε_{outside}+ε_{inside}=0
would be satisfied. Since the dielectric constants are not real the field would become only large but not infinite. In case of an oscillating electric field that is a part of the light wave, that large field would of course also result in a correspondingly large absorption by the metal. The oscillating electron cloud represents an alternating current that dissipates energy. In other words, the just discussed field enhancement is the cause of strong absorption peaks produced in metals nanospheres. Taking into account the complex dielectric constant one calculate the approximate absorption cross-section, provided that the imaginary part of the dielectric constant is small. Leaving out a few steps, one finds

$${Q}_{abs} = 12 x \frac{{ɛ}_{medium} {ɛ}_{imag}}{{( {ɛ}_{real} + 2 {ɛ}_{medium} )}^{2} + {ɛ}_{imag}^{2}}$$

In the above equation ε_{medium} is the dielectric constant of the medium, εᵣₑₐₗ and ε_{imag} are the real and imaginary parts of the dielectric constant of the metal sphere. The quantity x is given by
x=2πrN_{medium}/λ
where r is the sphere radius and λ is the vacuum wavelength. Again when that part of the denominator that is in brackets becomes zero, a maximum absorption is expected. For large values of absorption with a distinct and clearly delineated absorption region ε_{imag} should stay small. Obviously the maximum absorption wavelength shifts when the dielectric constant of the medium is changed. This would be a way of fine-tuning the color for a given metal.

It is important to note that the shape of the particle is important. The field inside the particle in relation to the field outside of the particle is very different for a disk. If the disk lies perpendicular to the direction of the field lines then

$${E}_{inside} = \frac{{ɛ}_{outside}}{{ɛ}_{inside}} {E}_{outside}$$

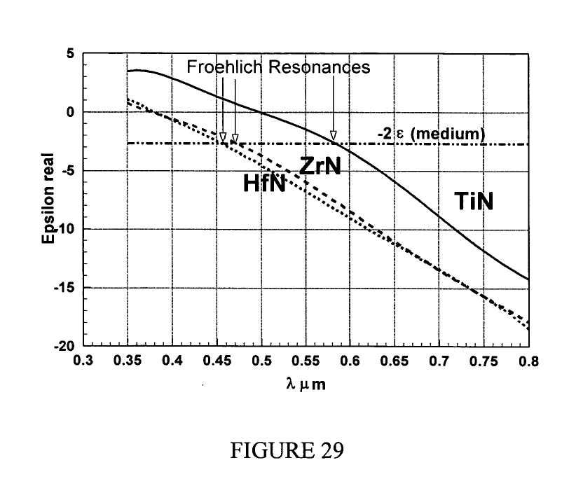

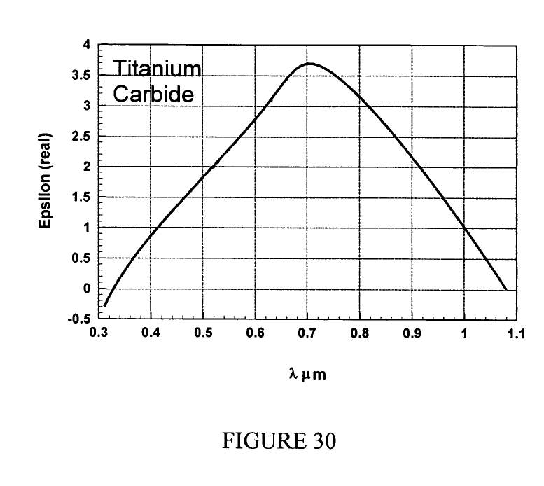

Here the resonance with the large absorption would occur at the position where ε_{inside}=0. The corresponding shift in wavelength of the resonance can be inferred from FIG. 29 below. If the disk were thin and aligned with the field then E_{inside}=E_{outside} and no singularity and thus no resonance would occur at all. A more detailed discussion of ellipsoidal shapes will be given towards the latter part of this paper.

For spheres the exact calculations proceed by using the previously discussed Mie theory. There is a small shift in wavelength of the absorption that comes from particle size. As the particle becomes larger the above simple considerations break down. Without proof, increase in particle size shifts the absorption peak slightly towards the red, i.e. longer wavelengths. Let us next discuss the absorption shift, when the dielectric constant of the medium is changed. The Drude theory gives an approximate value for the real part of the dielectric constant that varies as

$${ɛ}_{real} = 1 - \frac{{v}_{plasma}^{2}}{{v}^{2}}$$

where νₚₗₐₛₘₐ is the so-called plasma frequency and ν is the frequency of the light wave. The plasma frequency usually lies somewhere in the ultra violet portion of the spectrum. Gold spheres have an absorption peak near 5200 A. TiN, ZrN and HfN, which look also golden colored, have a peaks at shorter and longer wavelengths as we shall show below. TiN colloids have been seen to exhibit blue colors due to green and red absorption.

The above described behavior of the dielectric constants allows us to estimate how much the absorption peak shifts when the dielectric constant of the medium is changed. Using the above expressions in a simple Taylor series expansion up to the first order gives

$$Δ λ = {λ}_{0} \frac{Δ {ɛ}_{medium}}{3}$$

If the absorption maximum occurs at 6000 A, and we increase the dielectric constant of the medium by 0.25, then the absorption peak shifts up by 500 A to 6500 A. If we decrease the dielectric constant then the absorption shifts to shorter wavelengths. Please note that the absorption wavelengths of dielectric resonators spheres (silicon etc) are virtually totally unaffected by the dielectric constant of the surrounding medium. In FIG. 29 we show the real part of the dielectric constant of the metals TiN, ZrN and HfN.

It may be seen from FIG. 29 that the Froehlich resonance condition is satisfied in the visible spectrum. Later we want to look also at other compounds, especially those arising by alloying the above Nitrides with C. We have currently no published optical data for the compounds except for the real part of the dielectric constant of pure Titanium carbide. It is shown below.

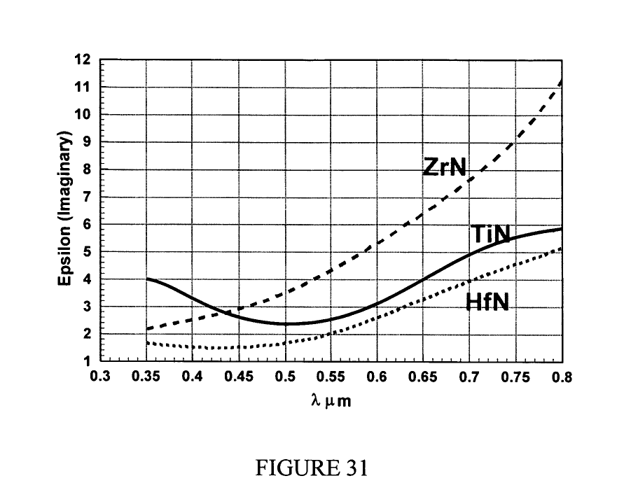

There may be for TiC perhaps two resonance conditions, one in the infrared and one in the ultraviolet. The alloys of the Nitrides with Carbon look to the eye silvery and thus a shift in the resonance is expected. Naively superimposing some of the dielectric constant of TiC on that of any of the three metallic Nitrides would make the combined dielectric constant more positive and therefore shift the resonance or absorption peak more towards longer wavelengths. Thus presumably a continuously variable color can be obtained. The latter statement is somewhat tentative, since no detailed measurements of the optical constants of those alloys that do exist, are available at this time. In the following FIG. 31 we also show the imaginary portion of the dielectric constant of the discussed Nitrides, which is responsible for the absorption.

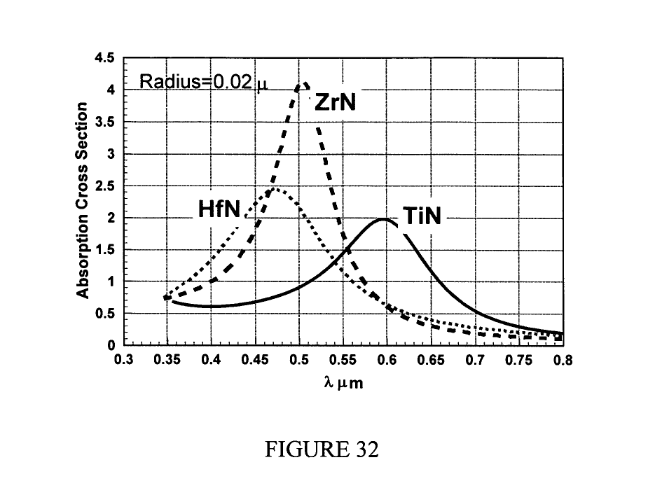

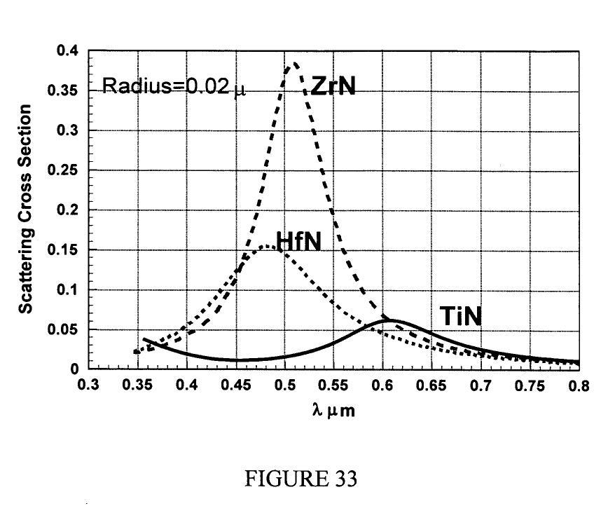

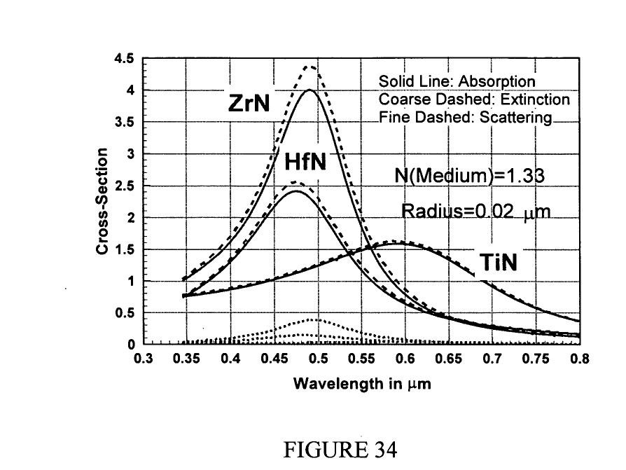

Results of numerical calculations are shown in FIG. 32 below.

Using the Mie theory we have calculated in FIG. 32 absorption cross sections for the above three metals using an index of 1.33 for the surrounding medium. The absorption peaks occur essentially where expected. The particle radius is 0.02 micron. Larger particles have an increased amount of scattering. Scattering peaks at the same wavelengths as does the absorption. However for the 0.02-micron radius scattering is negligible.

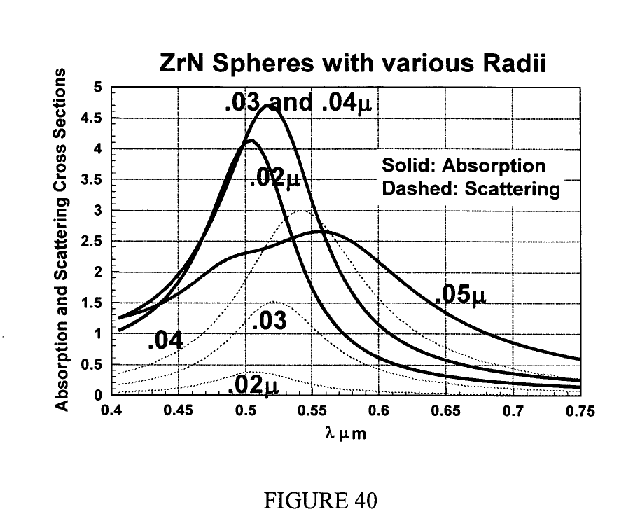

Further below we shall return to the behavior of absorption and scattering as a function of radius (compare FIG. 40 for ZrN).

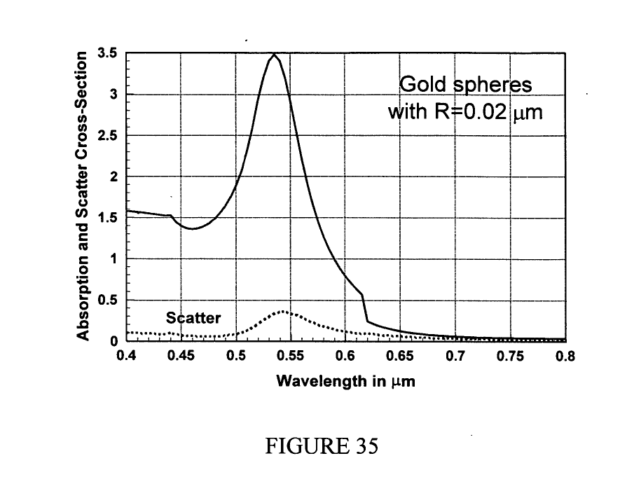

For comparison we show in FIG. 35 the behavior of gold spheres with a radius of 0.02 μm. The high absorption in the blue and green spectrum gives the deep red color of ancient ornamental glass windows. The absorption and scatter cross-sections of gold spheres are of comparable magnitude as those of the three Nitrides and thus one would expect rather pleasing colors from the Nitrides as well.

The above figures are based on the published data for the indices of the three metals TiN, ZrN, and HfN. It is known that the indices of some evaporated thin films deviate from the bulk data due to increased “free electron scattering”. Efforts have been made to fit the actual indices of refraction to those of a Drude free electron gas. The real and imaginary dielectric constants and the real and imaginary values of the indices of refraction N and K for free electron like metals follow the law

$$ɛ ( ω ) = {ɛ}_{1} + ⅈ {ɛ}_{2} = ɛ ( ω = ∞ ) - \frac{{ω}_{p}^{2} τ}{{ω}^{2} τ + ⅈ ω} \\ N + iK = \sqrt{ɛ ( ω )} = \sqrt{ɛ ( ω = ∞ ) - \frac{{ω}_{p}^{2} τ}{{ω}^{2} τ + ⅈ ω}}$$

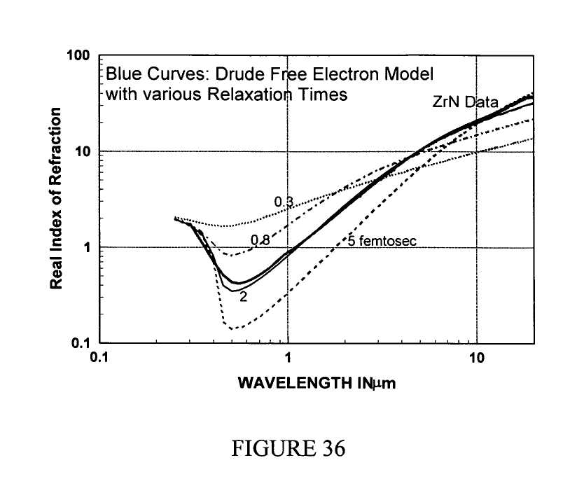

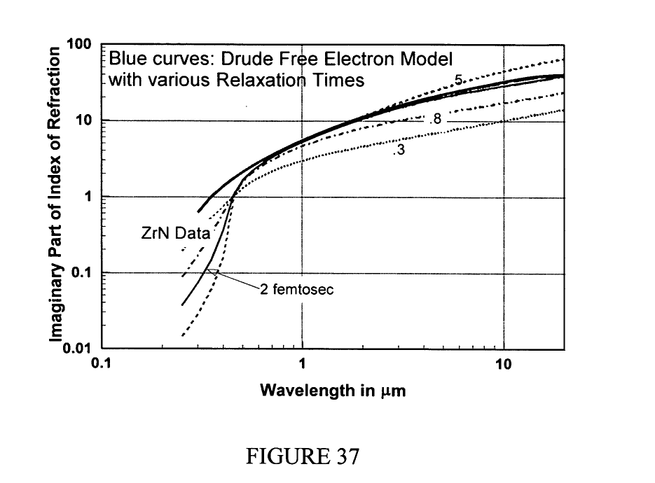

In the above equations ωₚ is the free electron plasma resonance related to the effective mass of the electrons while r is the electron relaxation time. For ZrN we use ε(ω=∞)=6 and ωₚ=1.101×10¹⁶ sec⁻¹ While the plasma resonance is fixed for a given material, the relaxation time is depending on the collision rate of electrons with phonons, the material surface and imperfections in the film. These imperfections can lower the relaxation time. Generally speaking, the desirable optical properties are unfavorably impacted by short relaxation times. Published data (compare FIG. 36 and FIG. 37) correspond to a 2 femtosecond relaxation time (1 femtosecond=10⁻¹⁵ sec).

The corresponding Drude Free Electron Model for the imaginary index of refraction is being shown in FIG. 37.

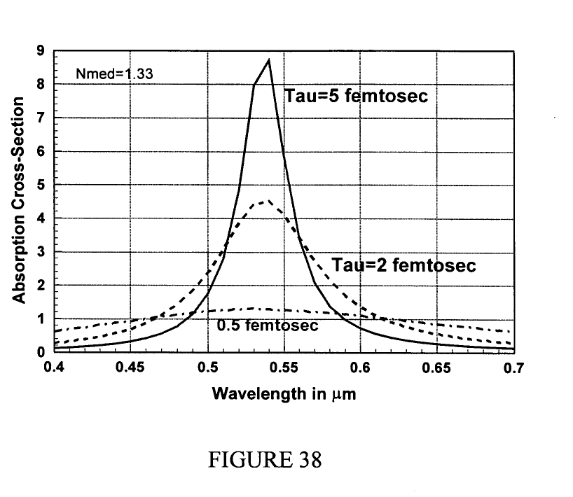

This absorption cross-section of a free electron gas like metal is shown in the next diagram (FIG. 38).

FIG. 38 shows that the relaxation times of the electron gas can be important. The best agreement with measured indices of refraction on thick films is with a 2-femtosec electron relaxation time. Some changes in the relaxation time can be obtained by the way the material has been prepared. Longer relaxation times are desirable.

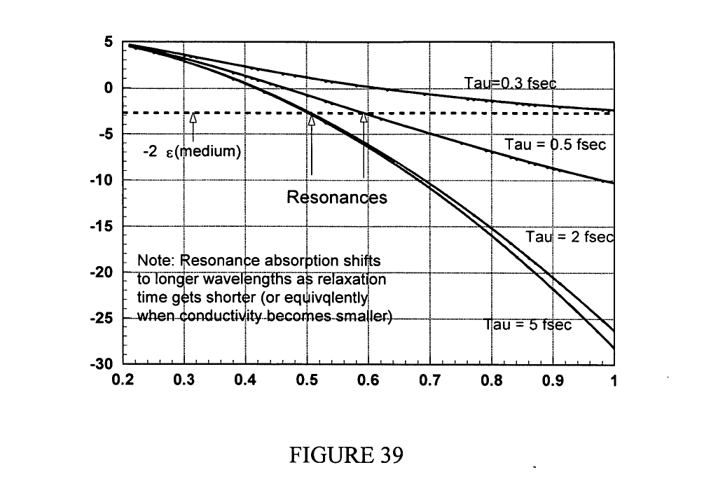

For short relaxation times the resonance becomes very weak as seen in FIG. 38 for ZrN. Also the nominal position of the Froehlich resonance, where 2ε_{outside}+ε_{inside}=0, tends to shift towards longer wavelengths, as illustrated in FIG. 39. Long electron scattering times and/or a good electronic conductivity are very important.

Next we shall study particle size in conjunction with FIG. 40 to FIG. 43.

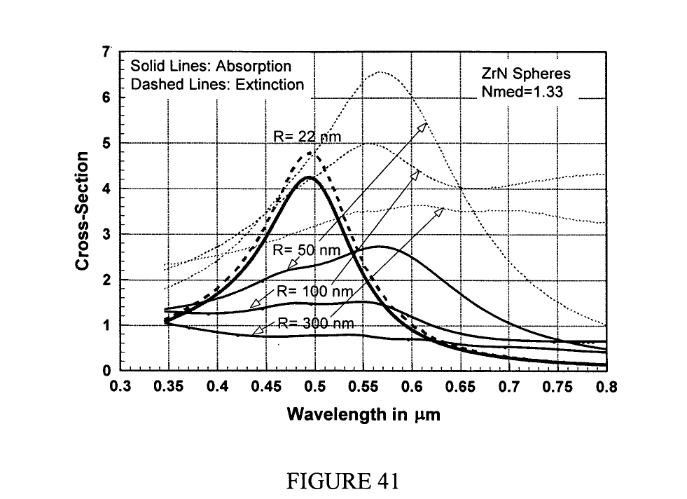

It is apparent from FIG. 40 that particles with radii of 0.04 micron and larger can scatter significantly. Thus particle size is again of importance. Larger particles become less effective as absorbers because the material occupying the innermost portion of the sphere never sees the light that they might absorb because the outer layers have already absorbed the incident resonance radiation. In the following FIG. 41 we show absorption and extinction cross sections of some larger ZrN spheres.

The extinction cross section is the sum of the absorption and scattering cross sections. For larger spheres the resonance character gradually vanishes. The absorption and extinction cross sections start to be less pronounced as the size of the sphere grows. Absorption and especially extinction shifts also more to the red, i.e. longer wavelengths.

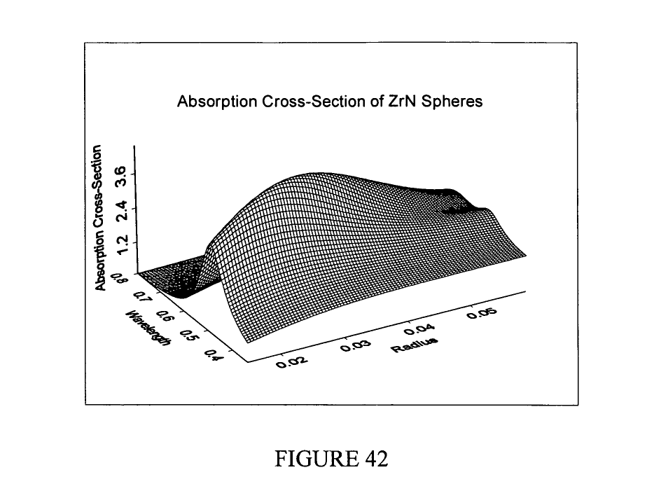

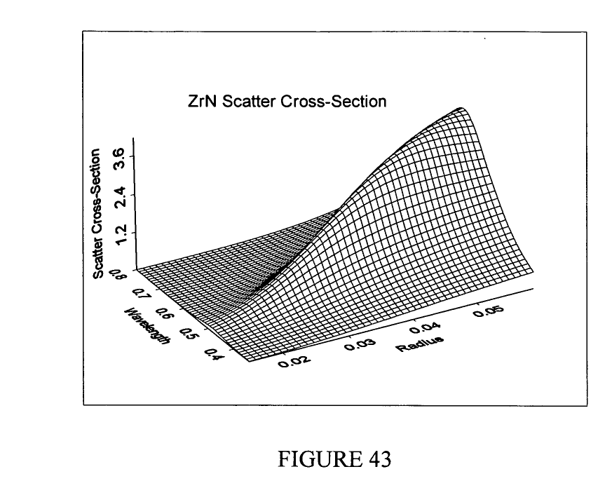

To further illustrate the behavior of the absorption and scatter cross-sections we also added 3D plots in FIG. 42 and FIG. 43. They show again that scattering is small as compared to absorption as long as the sphere radius is small, i.e. less than about 0.03 μm.

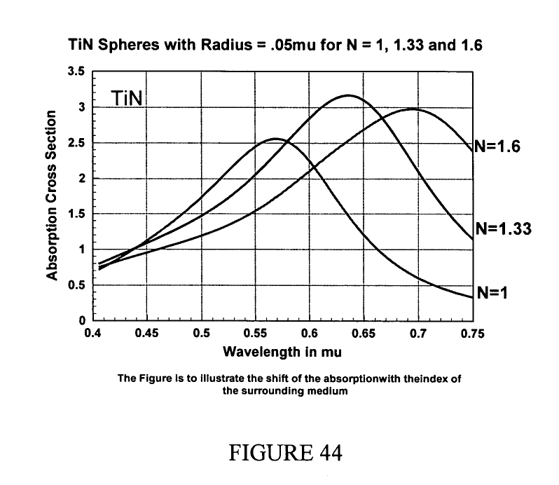

As mentioned above in conjunction with the exposition of the theory of the Froehlich resonance, the color is seen to shift in FIG. 44 as the index of the surrounding material changes. The illustration is for TiN spheres with a 0.05 micron radius.

Exploring Other Metals and Coated Metallic Particles as Well as Nonspherical Shapes

In the following we shall explore among others what happens when two different media are combined in a core/shell composite particle. We have already learned (FIG. 44) that a Froehlich or plasmon resonance is affected by the dielectric constant of the suspension medium in which the particle resides. Thus one expects that a high dielectric constant coating will also shift the plasmon resonance to the red. Similarly if the inner core of a metallic particle is replaced by a dielectric substance one similarly expects a red shift in the plasma resonance. The degree of the shift will depend on the magnitude of the dielectric constant as well as the thickness of the coating or the relative dimension of the dielectric core. Similarly we can have a nanosphere consist of two different metals. As we shall show, the resulting resonance lies somewhere in between the resonances of the pure metal spheres and also the position of the resonance depends on the relative size of the shell and the core.

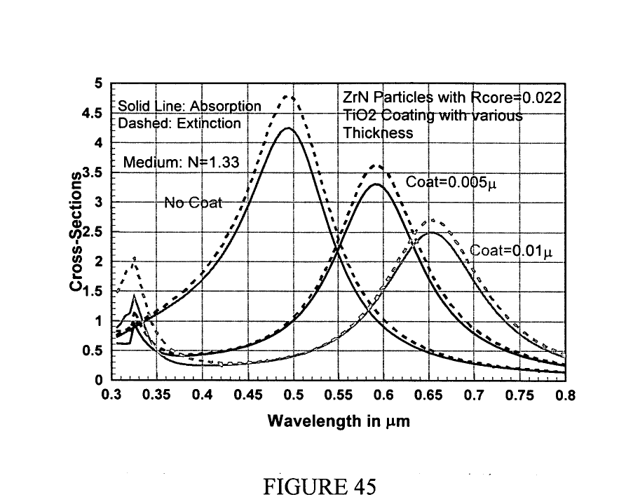

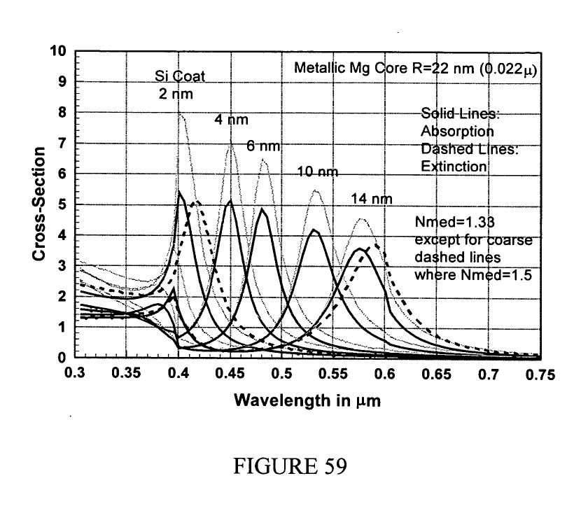

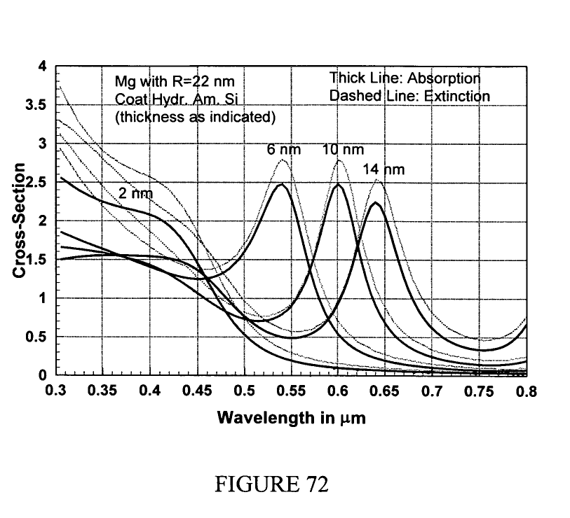

Let us begin with coating metallic particles with high dielectric constant materials while leaving the medium (paint carrier) unchanged. Depending on the thickness of the coating and the magnitude of the index of the coating a shift of the resonance line and color is seen. (FIG. 45, F, FIG. 59, FIG. 72) Usually the cross section based on the radius of the combined or coated particle decreases, but still stays comfortably above unity. If we were to define the cross section with respect to the active core particle alone then the cross section would in effect increase slightly upon coating.

In the following we shall make use of extensions of the Mie theory for particles which consist of a core with either one or two shells around it. In FIG. 45 we show ZrN cores coated with TiO₂ of a thickness of 5 and 10 nm.

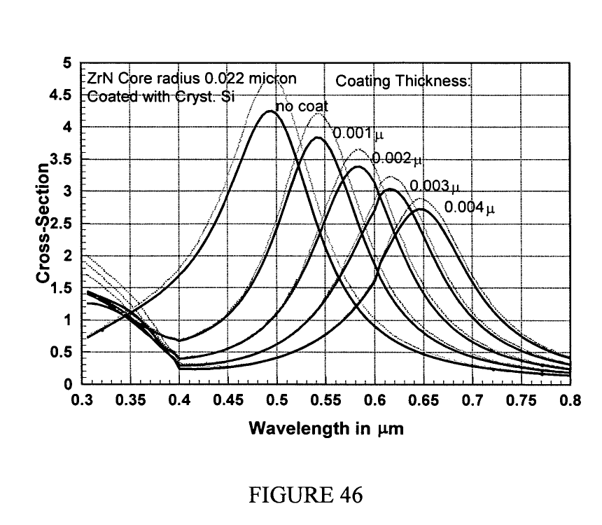

By using a coating with a higher dielectric constant material, such as crystalline Si a thinner coat is required for achieving a given absorption band shift. The absorption cross section is also slightly higher for the coating with the higher dielectric constant. This all is illustrated in the following FIG. 46.

TiN powder obtained from a source in Germany did show some of the expected features with an absorption peak, however the peak to valley ratios were not pronounced enough to make this powder a good pigment. The above calculations are based on measurements of the optical constants of bulk and thin film material. Stochiometry is important; otherwise the free electron relaxation rate increases and much inferior absorption characteristics will result. Not much quantitative information is available at this point in time. It is also very important that the small particles are spherical. Ellipsoids are discussed towards the end of this chapter. They would exhibit resonance behavior at other wavelengths and furthermore the wavelength would depend on the relative orientation of the particle axes with respect to the lightwave electric (E) vector.

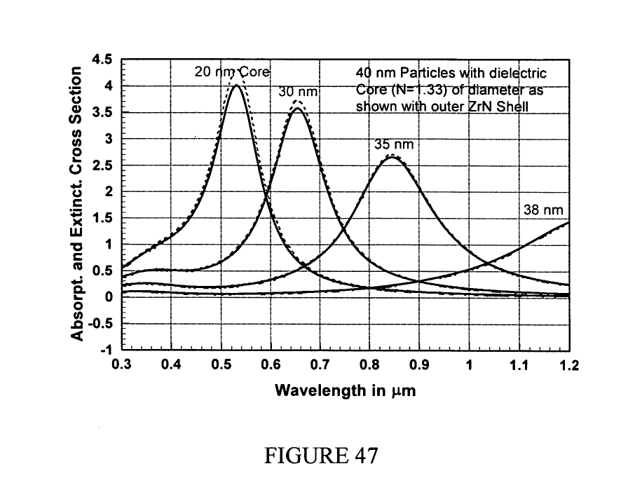

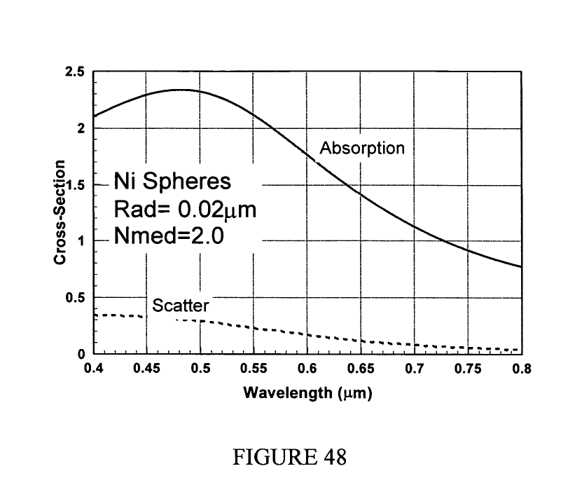

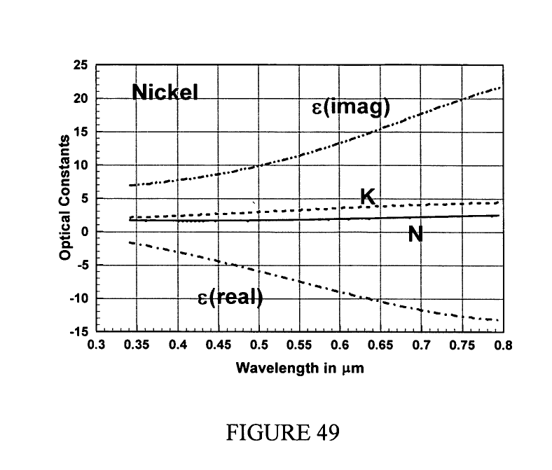

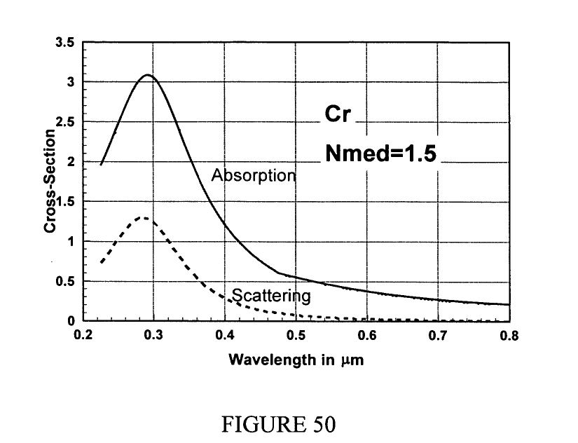

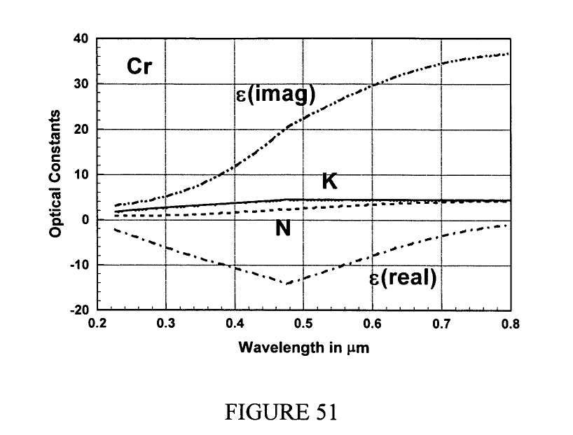

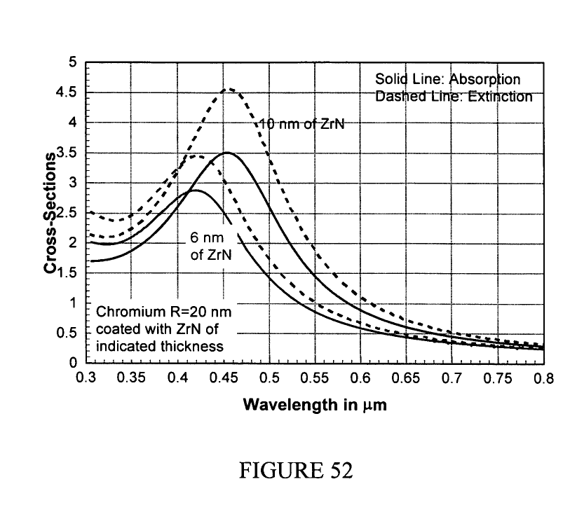

In FIG. 47 we show yet another way to shift the resonance to longer wavelengths. A dielectric core surrounded with a metallic material that exhibits a plasmon resonance also provides e means for achieving longer wavelengths resonances. In general this method achieves the best absorption characteristics with the sparing use of metals. The greater the volumetric fraction of the core the larger is the red shift. There are potentially other metals with a Froehlich resonance. We show below Ni spheres in a medium with N=1.5 (see FIG. 48). The resonance is here not as sharp as in the case of ZrN and the absorption becomes more diffuse. Other metals with a negative dielectric constant tend to have their Froehlich resonance in the ultraviolet portion of the optical spectrum. As an example we show the case of Chromium spheres (see FIG. 50 and FIG. 51) In cases where a Froehlich resonance is found in the uv spectrum a coating with a high dielectric constant can be employed to shift the resonance into the visible spectrum.

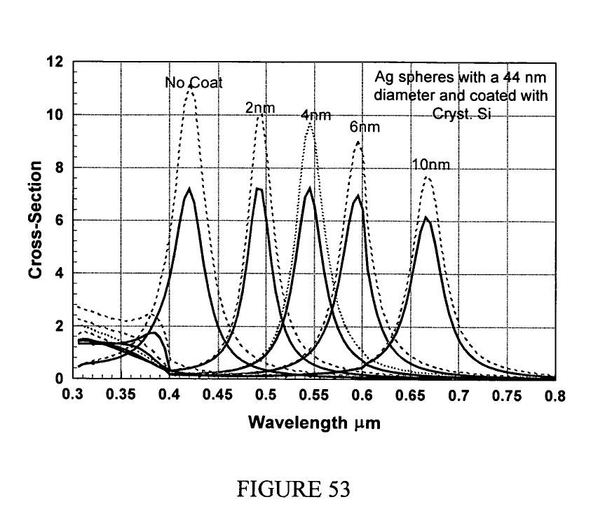

Ag metal is a very good free electron conductor. We show its resonance as a function of Silicon coating thickness in FIG. 53

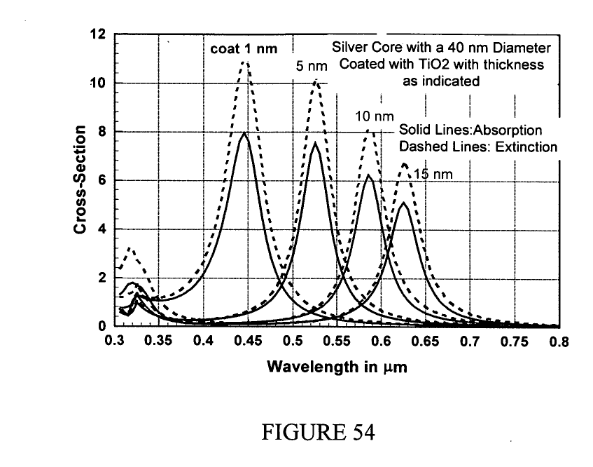

If we were to coat Silver spheres with TiO₂ then somewhat thicker coatings are needed as shown in FIG. 54.

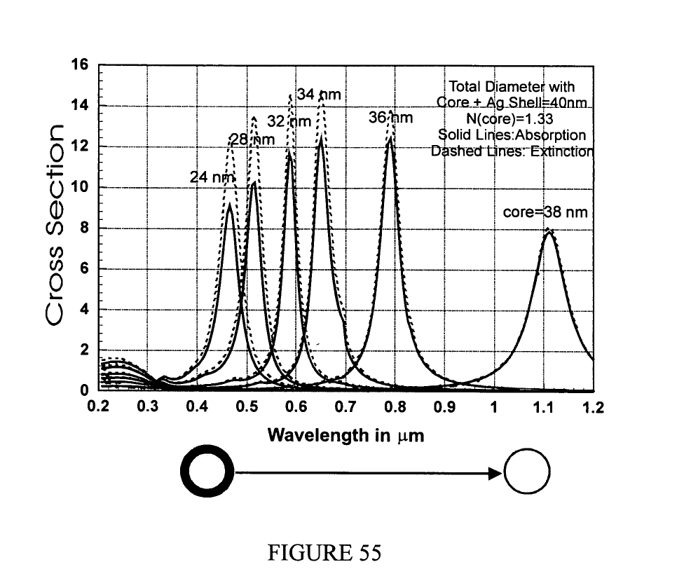

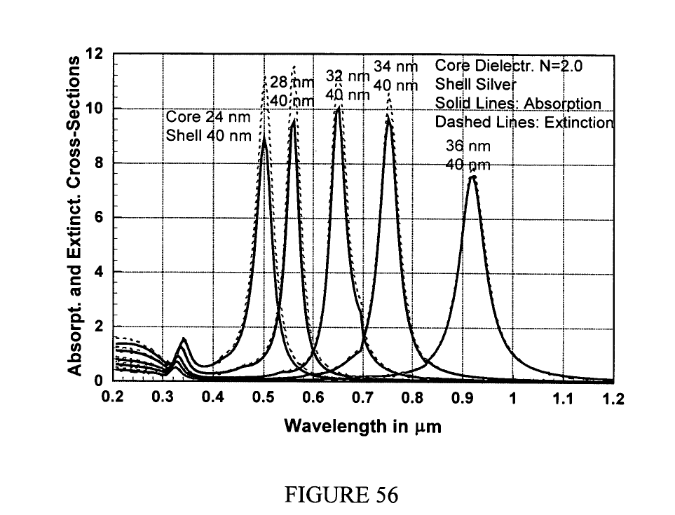

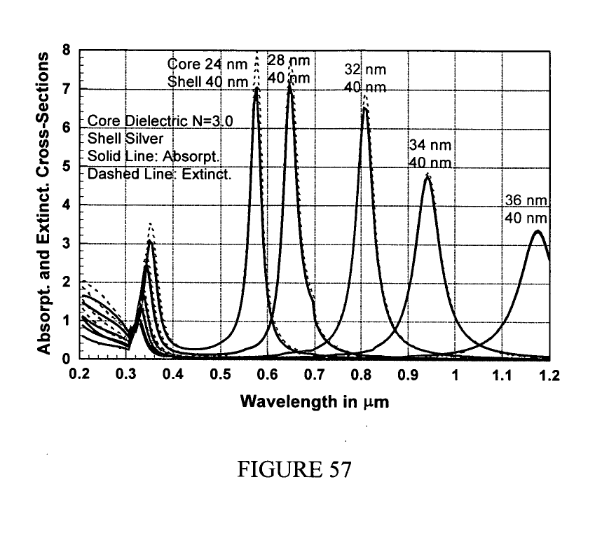

In FIG. 55 we calculate the absorption cross section of Silver spheres of 40 nm diameter for different sizes of an assumed dielectric core of index N=1.33. The medium is assumed to have an index of 1.33 also. As expected the resonance also shifts toward longer wavelengths as the core becomes relatively larger. Also in this case the resonance amplitude increases up to a point. However one nanometer Ag shells actually have a lower cross section as seen in the diagram. In actual experiments the very thin Ag layers in the large core cases may have shorter electron relaxation times and thus the predicted increased absorption cross section may in reality be less pronounced. FIG. 56 and FIG. 57 illustrate what happens when the index of refraction of the core is made larger.

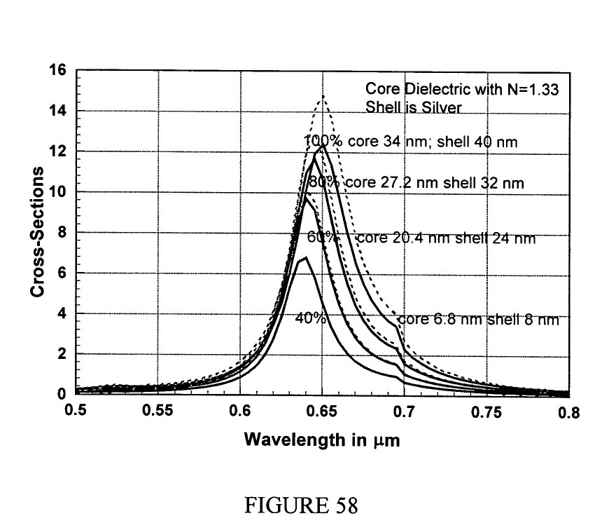

We see that a larger index of the core results in a larger red shift with a somewhat reduced amplitude for the absorption cross-section. In FIG. 58 we have uniformly scaled a given coated nanoparticle from arelative total size of 100% to 40% in decrements of 20%. The full size (100%) particle has a 34 nm diameter dielectric core with N=1.33 and a Silver shell with an outer diameter of 40 nm. Both the inner and outer diameter is scaled by the same percentage factor. The results are reminiscent of those for an uncoated ZrN particle depicted in FIG. 42 above. The resonance position is essentially unchanged by changing the particle size but the overall cross section is smaller for the very small particles. This was earlier explained by observing that the absolute size of the cross section for small particles is proportional to the mass of the particle.

In the FIG. 59 below we have examined Mg spheres. The bare particle has a resonance in the ultra violet spectrum. A coating of crystalline Silicon brings the resonance absorption into the visible spectrum. The absorption position is a function of the coating thickness, as illustrated. We also illustrated the absorption shift with the index of the medium. For the solid absorption lines N_{med}=1.33, for the two heavy dashed lines the index is 1.5. The fractional shift is smaller for the 14 nm coating thickness, as one would expect.

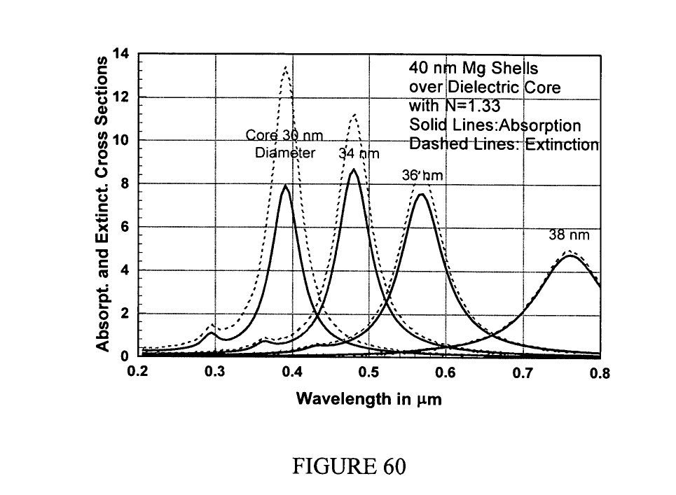

Alternatively one can coat a dielectric core with Mg metal (FIG. 60). The absorption lines are again red shifted. The red shift increases as the ratio of dielectric material to metal increases. The absorption cross sections are larger when compared to FIG. 59. This is as expected and it illustrates the special advantage which comes from the use of a dielectric core instead of a dielectric coating.

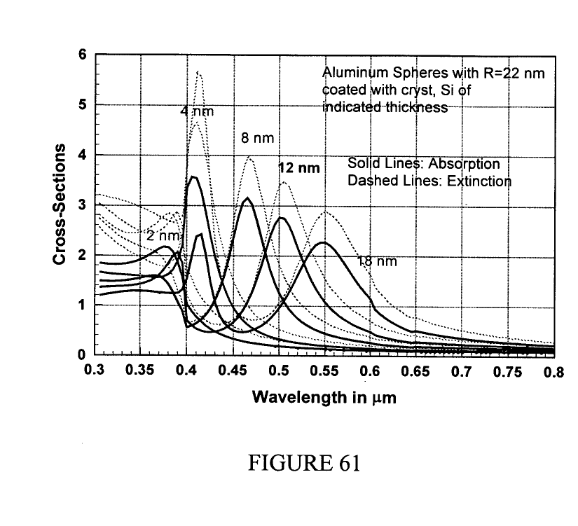

In a plot similar to that of FIG. 59 a 44 nm diameter Al core is coated with crystalline Si is and the results are presented in FIG. 61. Aluminum has a Froehlich resonance deeper in the ultra-violet spectrum. Thus a 2 nm Si coat brings the resonance not yet quite into the visible spectrum. The thick 18 nm Si coat (brown curve)makes a resonator exhibiting two modes: A Froehlich resonance is near 0.55 μm and a second mode near 0.42 μm is mainly a dielectric resonator mode, as discussed above in conjunction with pure Si spheres.

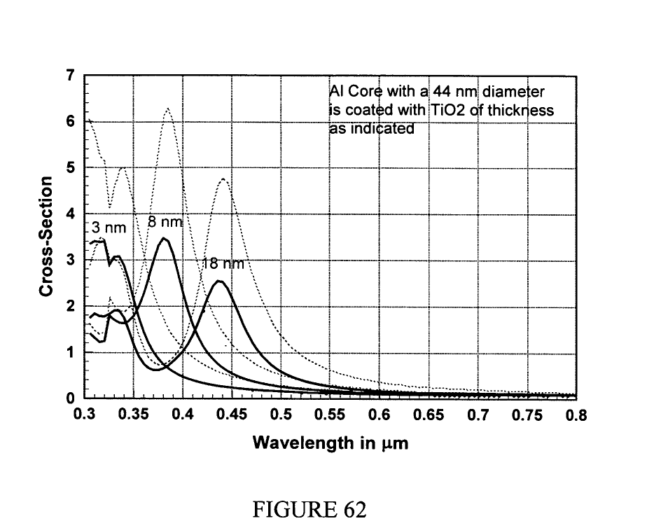

In FIG. 62 we show Aluminum spheres covered with coatings of TiO₂. Because of the lower index of TiO₂, as compared to Silicon, the absorption peaks are being shifted less than in the Si coating example.

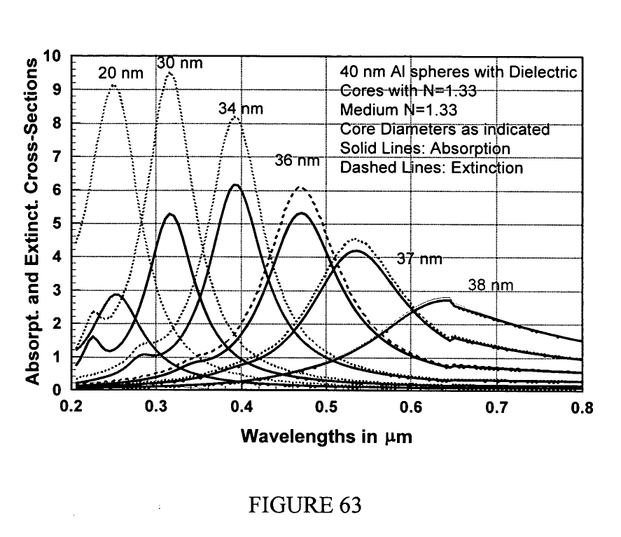

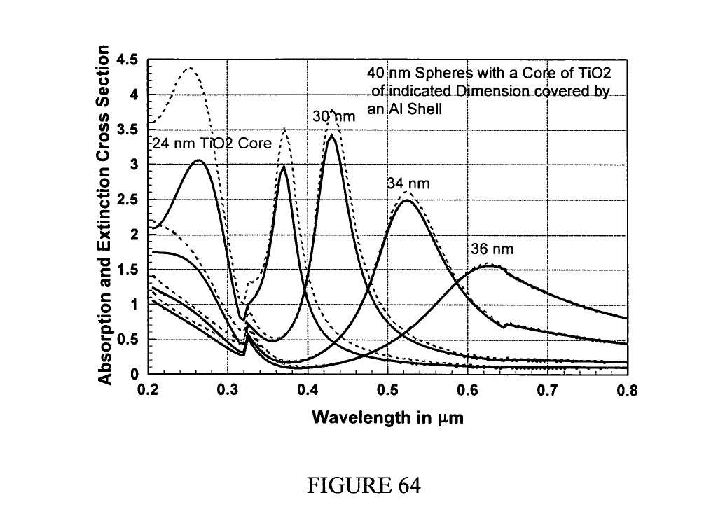

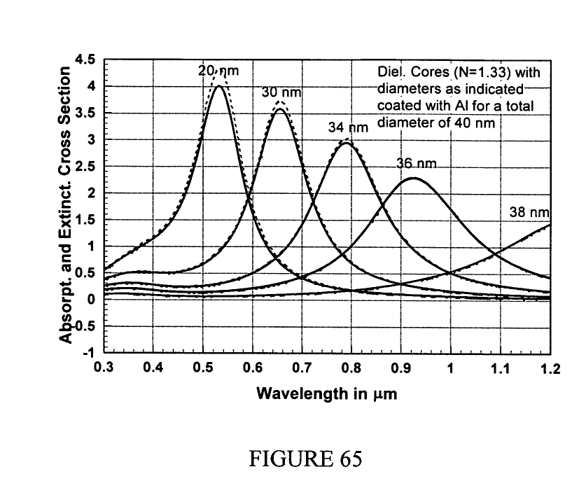

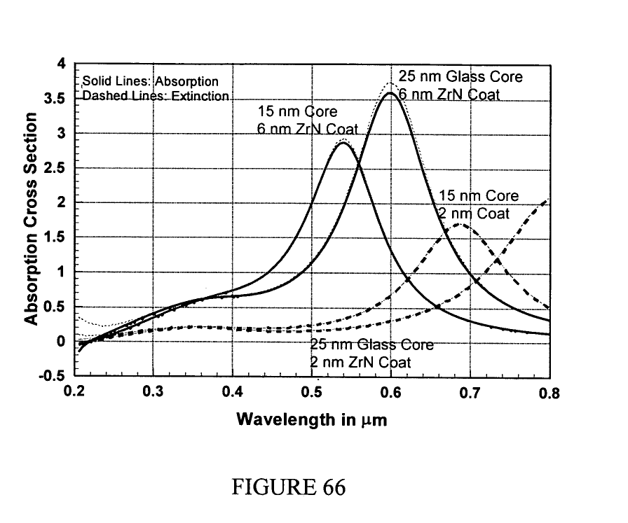

In FIG. 63 we show that similar results can be achieved by coating a dielectric core with Aluminum. By using a higher index core made from TiO₂ relatively larger red shifts are being observed as depicted in FIG. 64. As may be seen the amplitude of the absorption cross-section decreases, however, with the larger index core. The corresponding curves for a dielectric core coated with ZrN are shown in FIG. 65.

The effect of different core sizes on the resonance position is calculated in FIG. 66 for the case of two different size glass cores (N=1.33) coated with ZrN. For a given coating thickness increasing the core diameter will shift the resonance to longer wavelengths. On the other side, for a given core size, increasing the thickness of the metallic coat will shift the resonance more toward the pure metal (here ZrN) resonance position, In other words the resonance shifts towards shorter wavelengths.

We may summarise these observations by stating that the relative size of the core with respect to the metal shell is important. A relatively larger core and a higher index of the core give a larger red shift. A bigger metal shell moves the resonance toward the resonance wavelength of the pure metal metal sphere, i.e. towards shorter wavelengths.

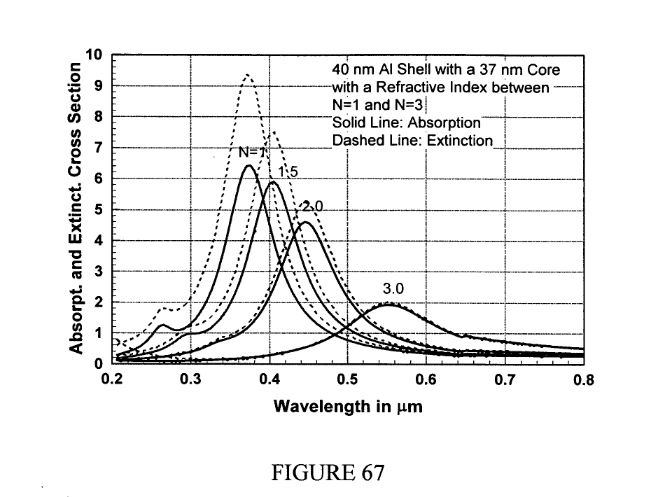

The red shift and the decrease in the absorption are studied below in greater detail in FIG. 67 for a 40 nm Al shell around a 34 nm dielectric core, where the core dielectric constant is varied between 1 and 3. We observe again that the higher the core index the more the Plasmon resonance is shifted to longer wavelengths while at the same time the magnitude of the absorption peak decreases.

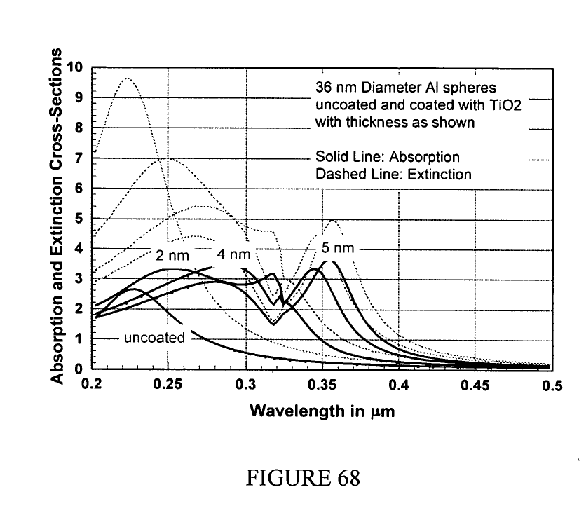

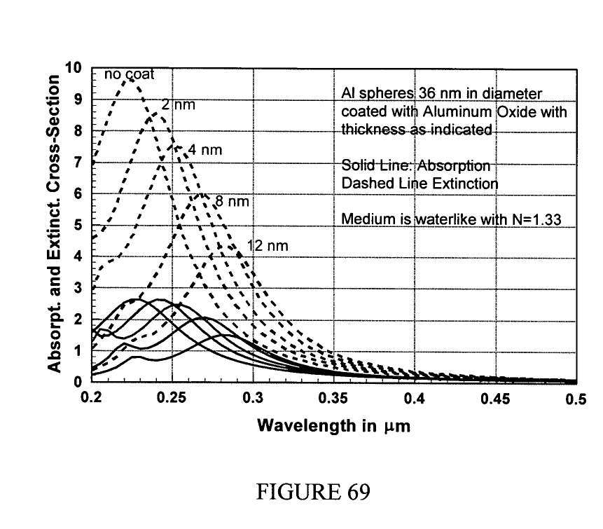

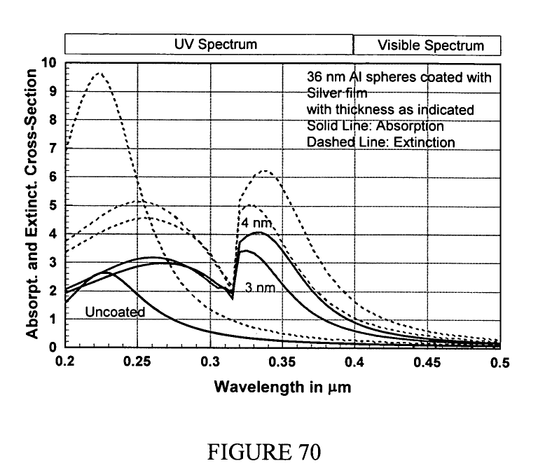

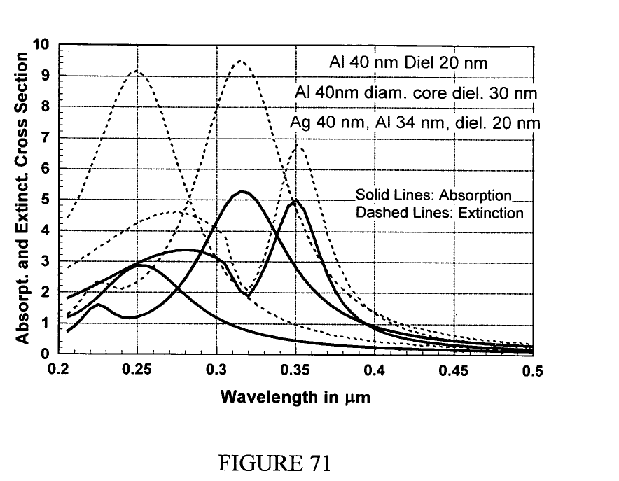

The strong uv absorption makes these particles also interesting from the point of view of uv protection, without causing much absorption in the visible spectrum. This is illustrated in greater detail in FIG. 68. Other examples for potential UV protection are depicted in FIG. 69, FIG. 70 and FIG. 71. Especially simple is the case in FIG. 69 where Aluminum nanoparticles are oxidized to various degrees. Because of the relatively low index of refraction of Al₂O₃ the amount of achievable “red” shift is more modest in comparison to TiO₂ or Si shells. Slightly better absorption cross-sections are obtained when a dielectric core is coated with Aluminum or from a combination of Aluminum and Silver (FIG. 71). In FIG. 72 we show the case of Magnesium spheres with a diameter of 44 nm coated with hydrogenated amorphous Silicon. Because of the much larger absorption of light by this form of Silicon the resulting resonance peaks are somewhat diminished and there is considerable absorption in the UV and blue portion of the spectrum as well.

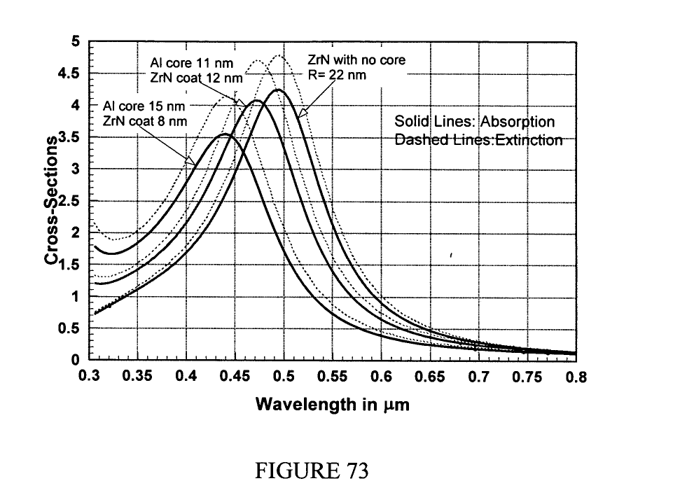

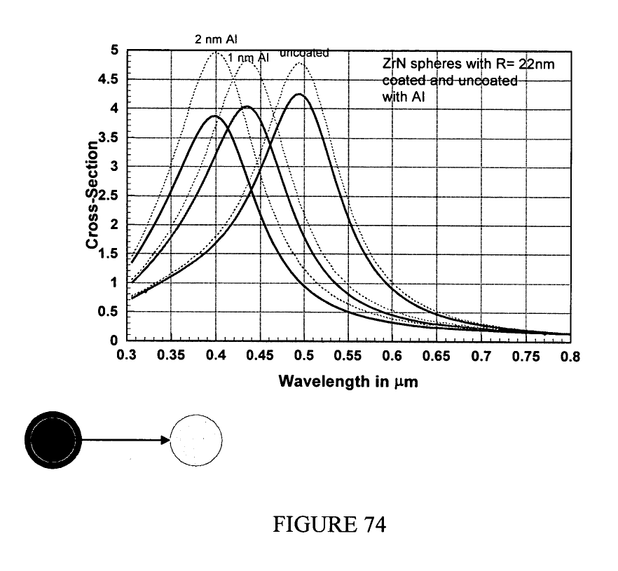

In summary, most metals that do have a Froehlich resonance have this resonance in the ultra violet spectrum. We can shift this resonance to the visible with a high dielectric constant (high index of refraction) coating, as was shown in FIG. 53, FIG. 59 or FIG. 72. A dielectric core coated with a suitable metal also results in a red shifted resonance. One can also coat ZrN with Al (or Mg) and shift the resonance of pure ZrN more toward shorter wavelengths (color tuning). Because of the reactivity of Al with oxygen it is better to use an Al core and coat it with a thick film of ZrN as shown in FIG. 73. For a theoretical comparison we also show in FIG. 74 the case where Al is deposited on a 22 nm ZrN sphere with a thickness of 1 and 2 nm. Because of the easy formation of Aluminum oxide this would not be suitable for most applications.

We have now shown in principle several ways to achieve virtually any desired position of the absorption peak. Thus also virtually any color can be obtained. The actual metallic substances and coatings used will depend in part on the least expensive methods of fabrication that can be devised.

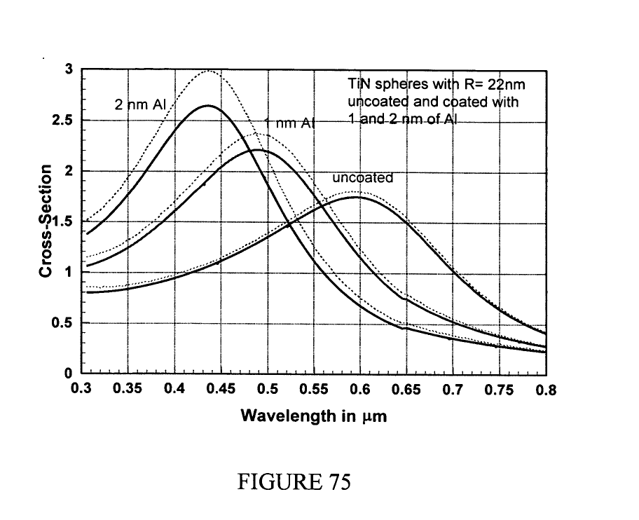

Similarly we have calculated in FIG. 75 what happens when we coat TiN spheres (R=22 nm) with 1 and 2 nm of Al. Obviously the absorption peak can be shifted from its uncoated sphere position at about 0.6 μm to any position towards the blue spectrum, depending on the thickness of the Al film. This is also what we found above for Al-coated ZrN spheres.

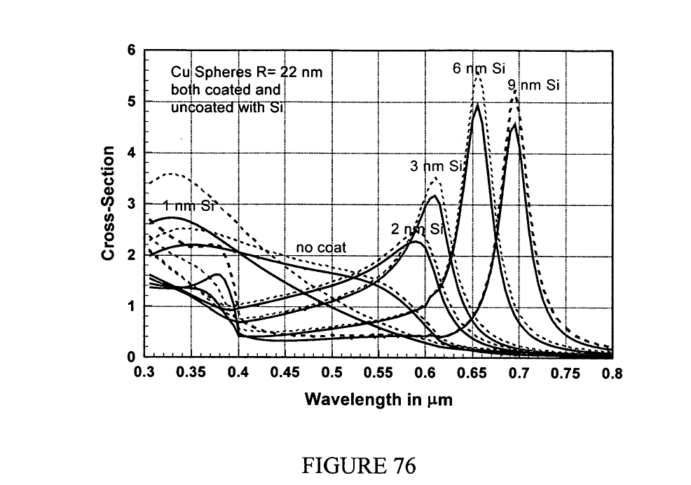

A similar result is found when we coat an Al core with TiN. Thus again the use of a suitable metal or high index films or cores can be employed for obtaining any hue of color desired. Copper spheres uncoated and coated show the absorption characteristics exhibited in FIG. 76.

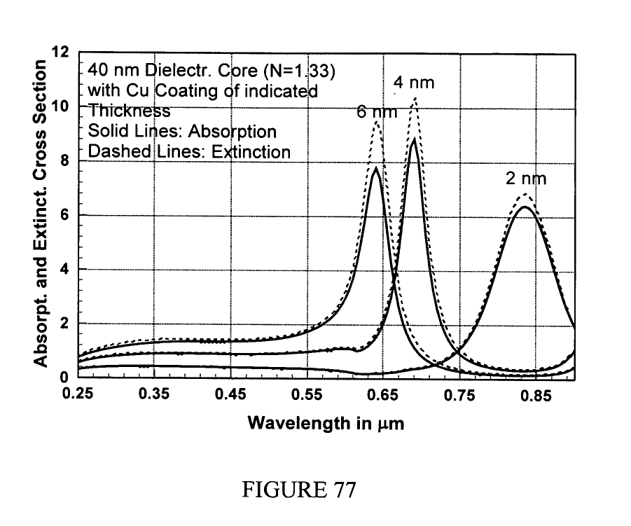

Similar results are obtained when a dielectric core is coated with Cu as illustrated in FIG. 77. The optical properties of Cu do not result in strong Froehlich resonances at wavelengths below about 0.55 μm due to undesired band-to-band electronic transitions in that wavelength band.

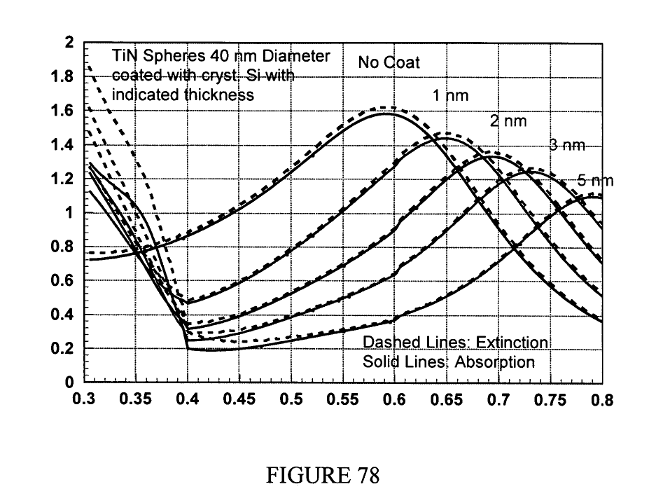

FIG. 78 illustrates the effects of a coating of high index cryst. Silicon on TiN spheres with a 40 nm diameter. As expected a red-shifted resonance is produced. The shift becomes larger as the coating thickness increases.

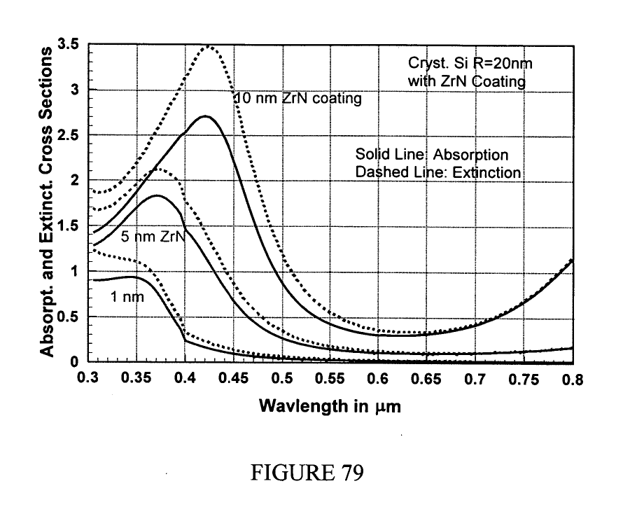

Below in FIG. 79 we illustrate how a silicon entrapment type resonance can interact with a Froehlich or plasmon resonance from a ZrN type coating. The pure Si resonance is expected between 0.3 and 0.4 μm while the pure ZrN resonance would be near 0.5 μm. The resulting perturbed resonance is now somewhere in between these values. In addition there is now deep in the infrared a new red-shifted “plasmon” resonance. This is not shown in the Figure because it is beyond the wavelength range of the plot.

We now investigate shortly particles having a core and two coatings.

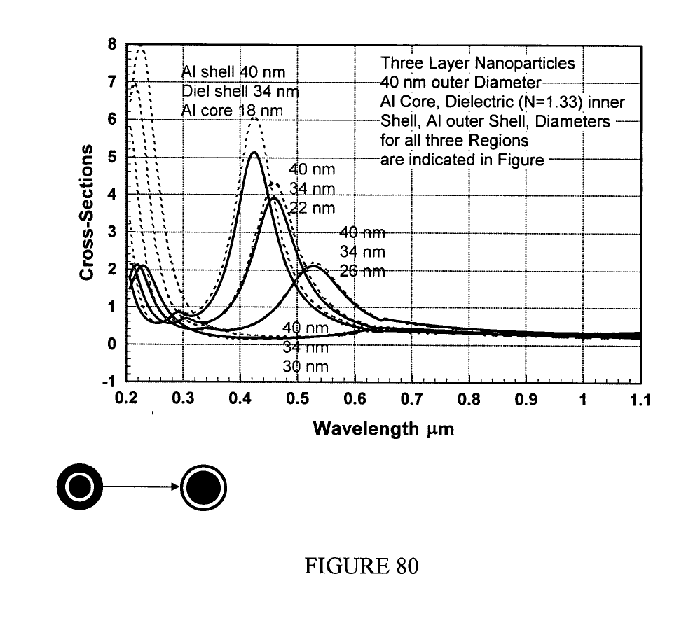

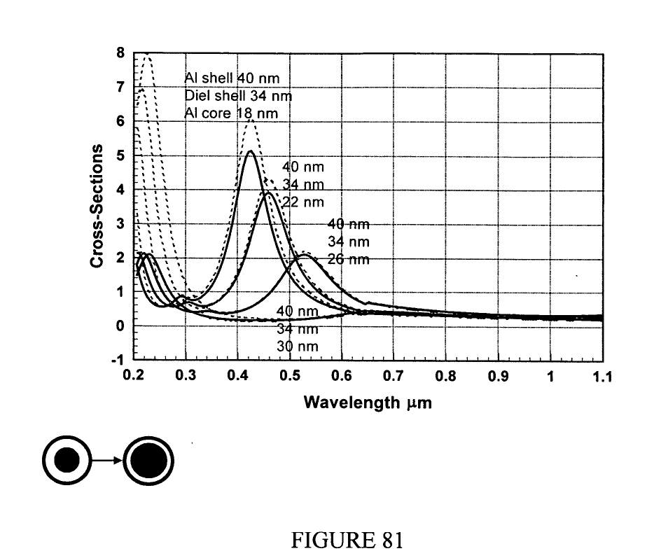

In FIG. 80 we have inserted into a homogeneous Al sphere a shell of a dielectric with N=1.33 and a thickness of 4 nm. The normally single deep UV resonance of Al is now joined by a second resonance. This resonance basically belongs to the outer Aluminum shell. It is shifted to the red and the red shift is the larger the thinner the outside Al shell. The amplitude of the resonance decreases as the outer shell becomes thinner. To obtain a better feeling for the behavior of double coated nanoparticles we have varied in the following diagram the thickness of the dielectric layer while leaving the outer shell dimensions the same.

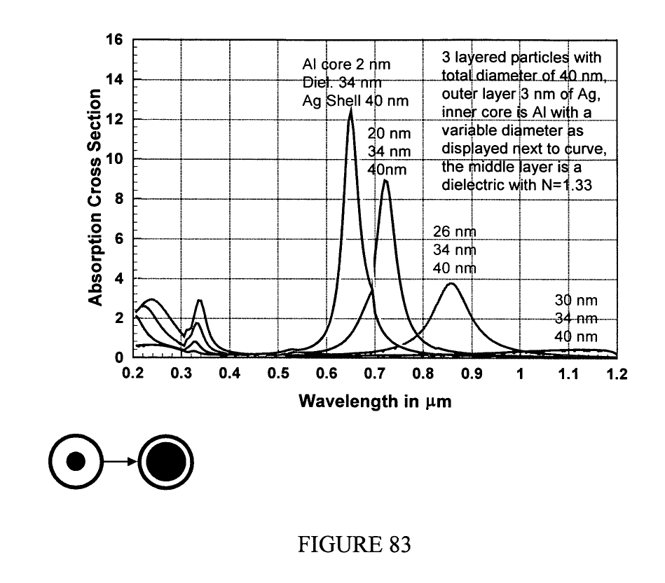

As the inner Al core is made smaller the resonance of the outer Al shell approaches that of a dielectric core coated with an Al shell. On the other hand as the inner Al shell becomes bigger and bigger we approach the situation of a solid Aluminum sphere with a deep uv resonance only (dark green curve). Qualitatively similar results are expected from particles where the Al is substituted by Ag, Mg or other metallic substances with a Froehlich resonance. We have chosen below another example consisting of a simple dielectric with N=1.33 and sections of Al and Ag in different order. The total particle diameter is 40 nm. Each of the three sections occupies one third of the total particle volume. A dielectric at the core shifts the resonance toward longer wavelengths. A dielectric as the middle layer also shifts the resonance towards longer wavelengths but not quite as much. A dielectric outside actually corresponds to only a two-layer particle that is smaller because the dielectric constant of 1.33 was chosen to coincide with the medium into which the particle is embedded. The outer layer becomes indistinguishable from the medium, however, and for ease of comparison, the cross section is still calculated based upon an assumed 40 nm particle size. Also note the enclosed dielectric increases the amplitude of the resonance peak. Again it is most effective in the position of the core and a little less effective when occupying the middle layer. Dielectrics can often be used to produce larger absorption cross sections as has been seen above in several examples. In FIG. 83 we chose a case where the volume fractions are very different. The outer Silver layer is relatively thin with a layer thickness of 3 nm. The 2 nm Al core (black curve) is virtually indistinguishable from a noncomposite dielectric core coated with 3 nm of Silver. Even a 10 nm core gives a curve that is hardly differentiated from the depicted black curve. As the core grows the major resonance peak shifts towards the red and into the infrared while losing strength as an absorber.

For a 30 nm Al core the long wavelength resonance virtually disappears while a weaker resonance builds up in the ultraviolet at wavelength values between those of pure Al and Ag plasmon resonances.

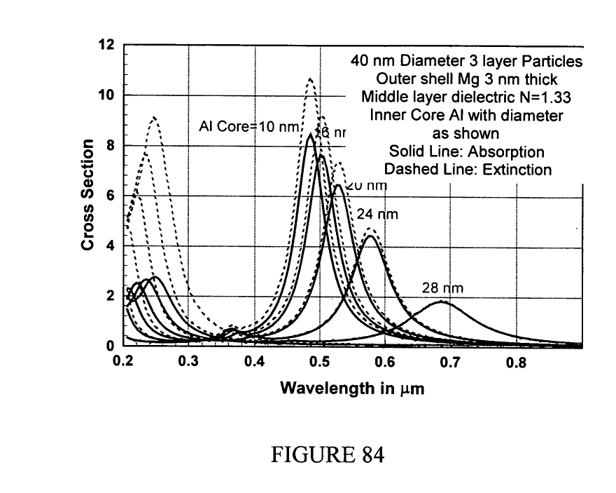

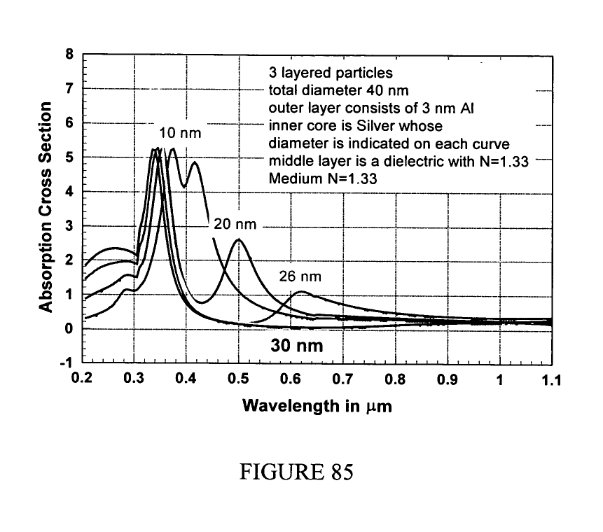

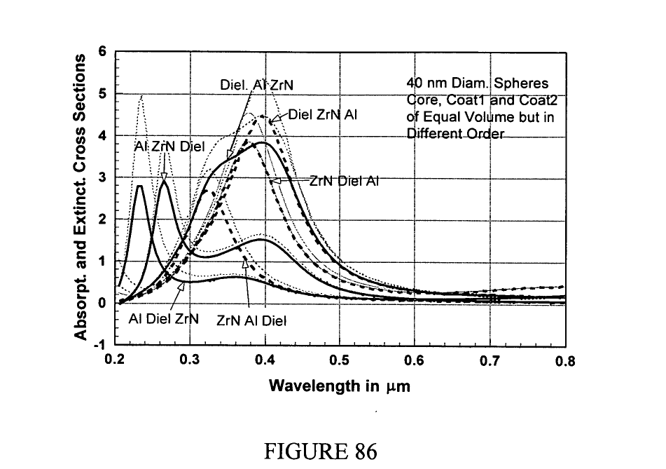

FIG. 84 is showing the cross sections for a case, which is very similar to FIG. 83. The only material difference is that Silver has been replaced by Magnesium. The resulting absorption spectrum is rather similar. The situation becomes rather different in FIG. 85 where we calculate a diagram where now the outer layer is made from Aluminum and the core is made from Silver. For a 30 nm Silver core we have only one plasmon resonance that is very slightly pushed to shorter wavelengths when compared to a simple Silver particle. For a 26 nm Silver core a weak resonance appears near 0.63 μm while the strong resonance between 0.3 and 0.4 μm is not much changed from the case with a 30 nm core. As the core shrinks to 20 nm the longer wavelength resonance grows and moves to about 0.5 μm. Again the short wavelength resonance is little changed. For a 10 nm core the long wavelength resonance shifts further to shorter wavelengths while the short wavelength uv resonance is pulled to slightly longer wavelengths almost merging with the other resonance.

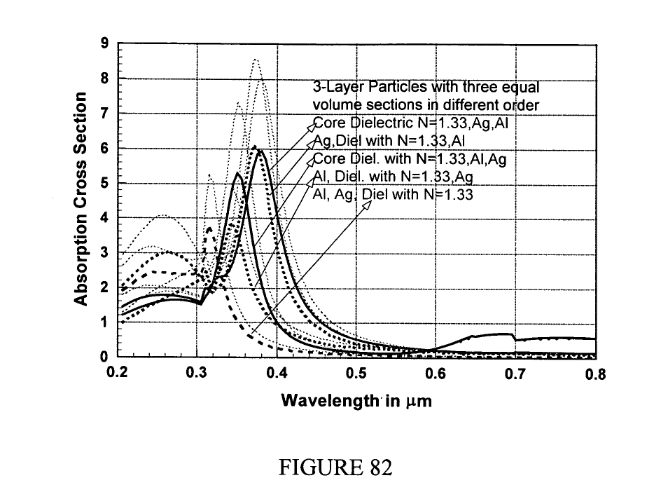

Another example of a three-component particle similar to that of FIG. 82 is shown below. Here the Silver is replaced by ZrN.

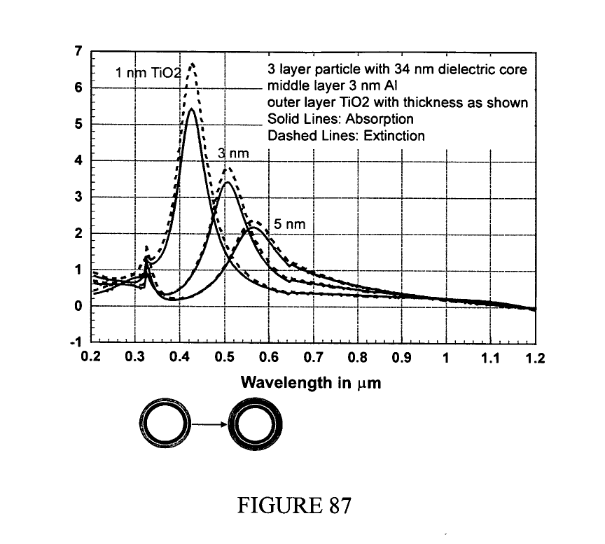

In FIG. 87 we show how two techniques can be applied simultaneously to achieve large red shifts of the Al plasmon resonance. As we have shown above a metal shell on a dielectric core causes the plasmon resonance to be red shifted. The shift is the larger the thinner the metal. We have also shown earlier that a high dielectric constant coating can also produce a red shift when applied to a metallic sphere with a plasmon resonance. Both techniques can be applied simultaneously, as shown here. Their effects are additive. In this way one can achieve large shifts.

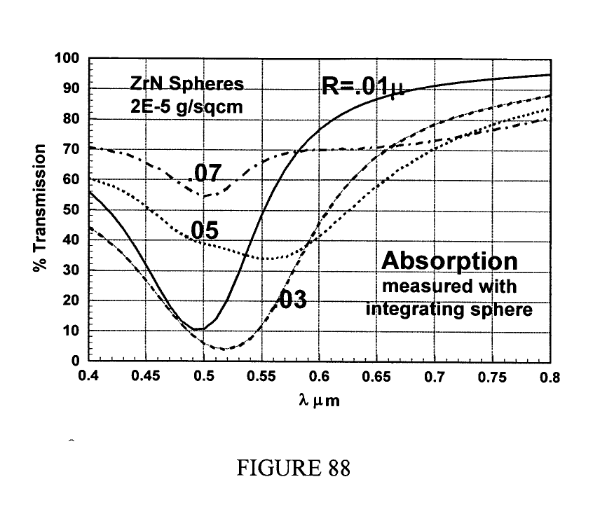

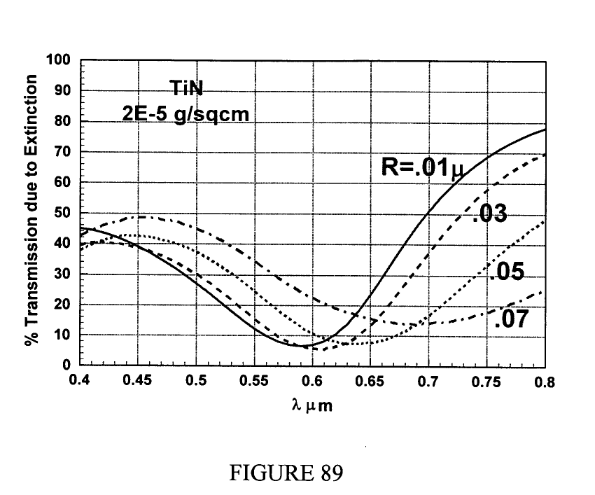

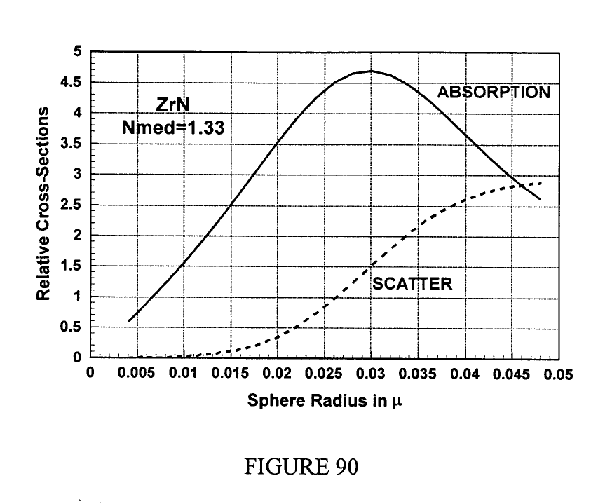

We shift now our attention to the effect of particle size. To actually determine optimal particle sizes it is best to plot transmission, absorption and extinction. It is true that the absorption cross-section decreases for small particles. However, there are many more particles present per unit weight than big particles. Interestingly, it appears that small particles of a given total mass absorb just about as well as somewhat larger particles with the same total mass. Most importantly small particles do not scatter. These points are illustrated in FIG. 88 and FIG. 89 below for TiN.

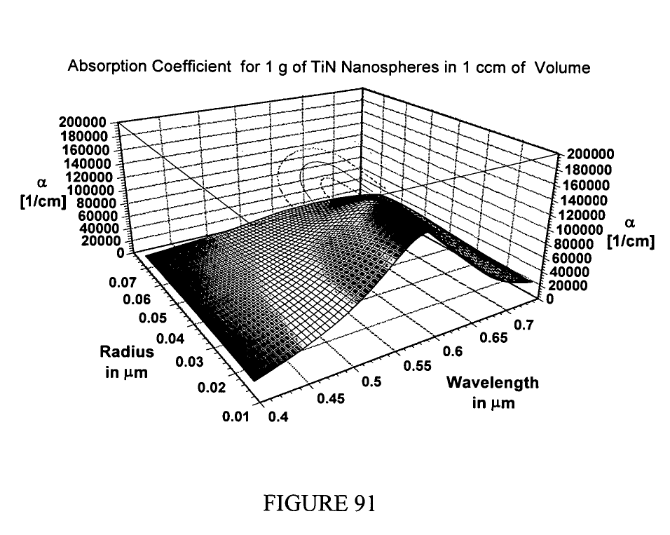

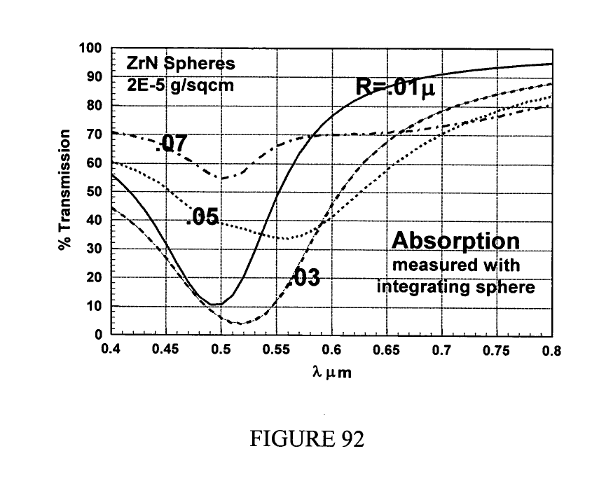

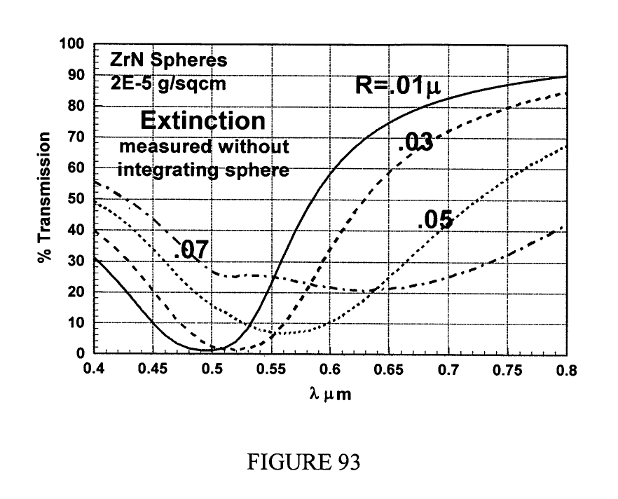

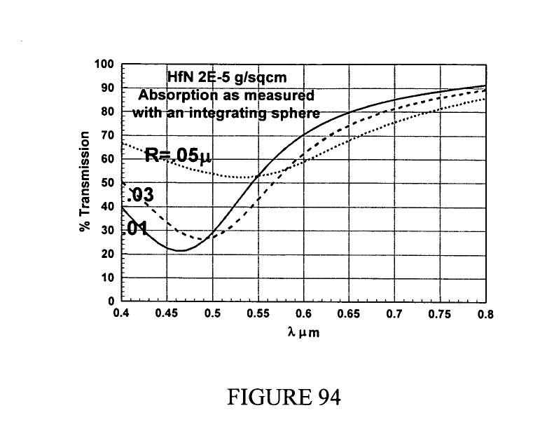

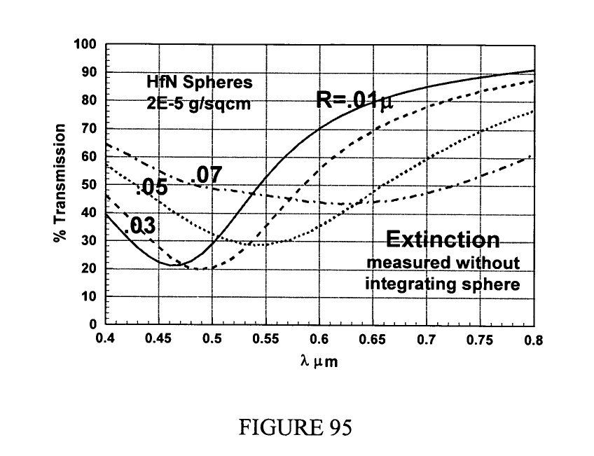

If one were to consider a given mass of particles, where the particles had different radii, one can calculate the absorption coefficient due to true absorption, neglecting scatter, of a suspension of such particles. Please remember scatter only plays a role for larger particles. This is illustrated in the FIG. 91, where 1 g of particles is considered suspended in 1 cm³ of a medium such as water. Up to a maximum radius of about 0.025 micrometer the magnitude of absorption does not depend on particle radius. This means that the relative absorption cross-section varies proportional to the radius r of the particle for radii smaller than about 0.25 micrometer (compare). Thus the total absorption cross-section is proportional to the physical cross-section πr² multiplied with the relative cross-section, which is proportional to r. In other words the total absorption cross-section of a small particle varies as r³, just as the volume of the particle. Thus absorption by small particles varies as the volume or mass of the particles. Physically speaking this is how it should be. The larger particles lose effectiveness because the light wave cannot penetrate to the center of a large particle because of absorption in the outer portion of the large sphere. In small particles all the material contributes to absorption.

Corresponding curves are shown for HfN below. Since HfN is rather heavy there are fewer molecules per gram of material and thus the absorption is relatively lower.

Let us now quickly examine how much change in the absorption characteristics can be expected from nonspherical particles. We shall restrict ourselves to particles that are very small when compared to a wavelength. In particular we shall study ellipsoids with rotational symmetry around one axis, because generally valid formulas can be generated by analytic means. Just as in a sphere an ellipsoid develops inside its boundaries a constant electric field when it is immersed into a uniform electric field on the outside. An important difference to the case of the sphere is the fact that the inside field does not have to be parallel to the outside field. For zero or negative values of the real dielectric constant at the light frequencies it is again possible to have situations where the inside field can have a singularity, provided that there is no imaginary part of the dielectric constant. In general we do have however an imaginary part of the dielectric constant and thus no infinite electric fields are generated, only relative large ones. This leads in the usual way to absorption peaks as found in the case of spheres. The formulas become longer (C. F. Bohren, D. F. Huffman, Absorption and Scattering of Light by Small Particles, John Wiley & Sons, New York 1983). While the condition for resonance for a sphere was
ε_{inside}=2ε_{medium}
This formula is now replaced by
ε_{inside}=F ε_{medium}
Here F depends on the eccentricity e of the ellipsoid, on the direction of the field with respect to the axes, and whether the ellipsoid is cigar like (prolate) with a>b=c or pancake like (oblate) with a=b>.c. Furthermore a,b,c are the lengths of the three axes of the ellipsoid. Without proof the required formulas will be given in the following.

$${F}_{1 cig} = 1 - \frac{1}{{L}_{1 cig}}$$

$${L}_{1 cig} = {g}^{2} ( - 1 + \frac{1}{2 e} ln \frac{1 + e}{1 - e} )$$

$$e = 1 - \frac{{c}^{2}}{{a}^{2}} ; g = \frac{{( 1 - {e}^{2} )}^{\frac{1}{2}}}{e}$$

We mean by F_{1cig} that this factor applies to a cigar shaped particle with the field direction parallel to the major “a” axis of the ellipsoid. The other axes b and c, have the same numeric value by symmetry. The eccentricity e is defined in the above equations. In the following equations F_{3cig} refers to the factor for an E field applied parallel to either the b or c axis. The other equations including those for an oblate ellipsoid are also given:

$${F}_{3 cig} = 1 - \frac{1}{{L}_{3 cig}} ; {L}_{3 cig} = \frac{1 - {L}_{1 cig}}{2}$$

$${F}_{1 pan} = 1 - \frac{1}{{L}_{1 pan}}$$

$${L}_{{1}_{pan}} = \frac{g}{2 {ⅇ}^{2}} ( \frac{π}{2} - {tan}^{- 1} g ) - \frac{{g}^{2}}{2}$$

$${F}_{3 pan} = 1 - \frac{1}{{L}_{3 pan}} ; {L}_{3 pan} = 1 - 2 {L}_{1 pan}$$

Similarly F₁ₚₐₙ or F₃ₚₐₙ refers to an oblate ellipsoid with the field direction along either of the two major axes or along the minor axis, resp.
Using a simplified form for the real part of the dielectric constant for ZrN
ε_{particle}≅8.7−44.122λ²

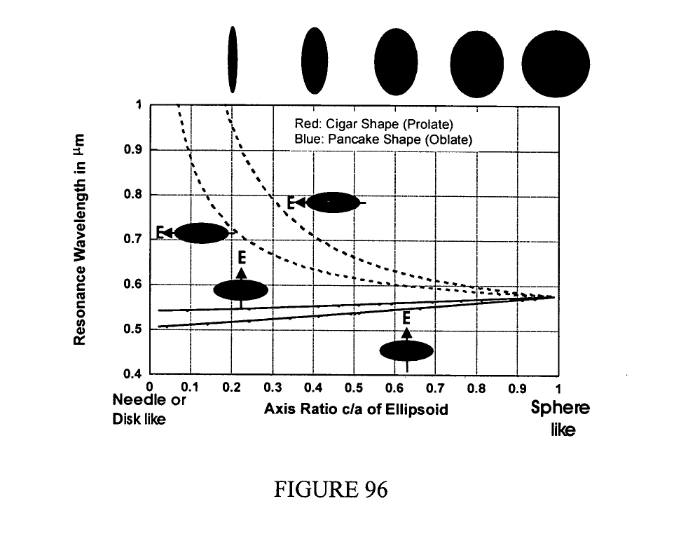

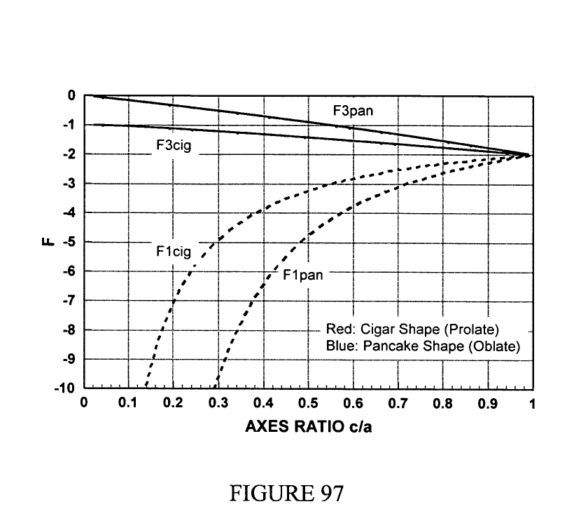

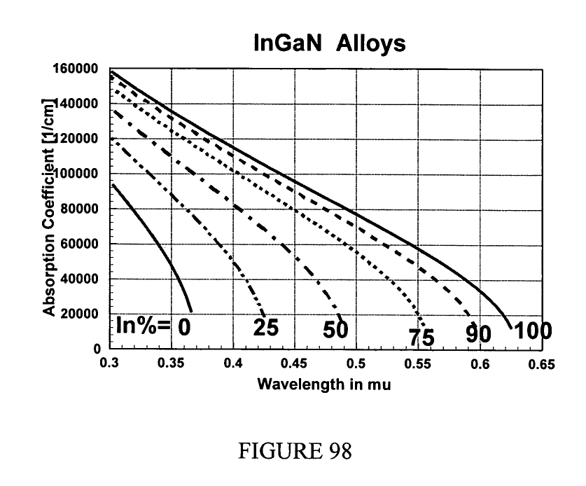

We have evaluated the expected resonance wavelengths for both oblate and prolate ellipsoids in FIG. 96.

In studying FIG. 96 it appears that the resonance wavelengths of the prolate particle form stay closer to those of the sphere. From a practical point of view one probably can tolerate values of a/c down to a value of 0.6.

To use the formulas for different materials with different dielectric constants we have plotted the four F functions, defined above in

Band Gap Induced Color and Thin Film Absorption

By working with strongly absorbing semiconductors one can use band gaps to produce a transmission cutoff at a certain wavelength and thereby produce certain colors. For a band gap separation E_{g} all photons with energy h ν larger than E_{g} can induce a transition from the valence to the conduction band. Thus frequencies larger than E_{g}/h will be strongly absorbed. Similarly all wavelengths shorter than hc/E_{g} will likewise be strongly absorbed. If these cutoffs are in the visible spectrum then these materials or pigments made from them will appear colored. For example a cutoff at 0.5-micron wavelength will absorb all blue radiation and it will therefore look yellow to the eye. As an example one can mention ZnSe, which has a cutoff at about 0.47 micron. A cutoff at 0.6 micron will absorb all blue and green radiation and to the eye it will look red. There are several known band gap materials that have cutoffs in the visible spectrum. In particular there are alloys of direct semiconductors, which, depending upon their composition, can be made to have almost any cutoff in the visible spectrum. Such systems are GaₓIn₁₋ₓ N or AlₓIn₁₋ₓ N and others. Below we show the absorption coefficient exhibited by the GaₓIn₁₋ₓ N system.

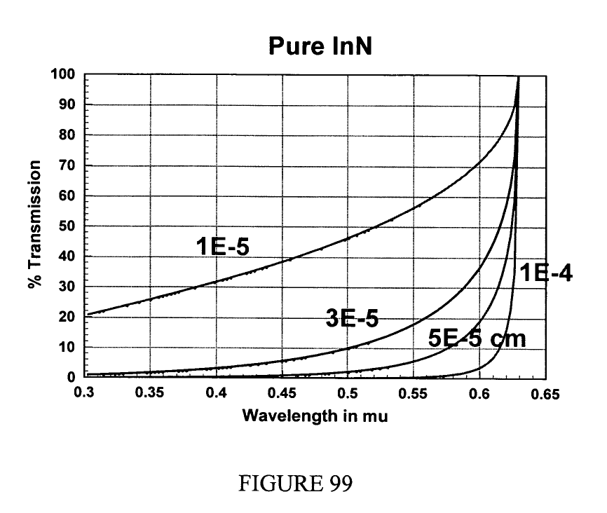

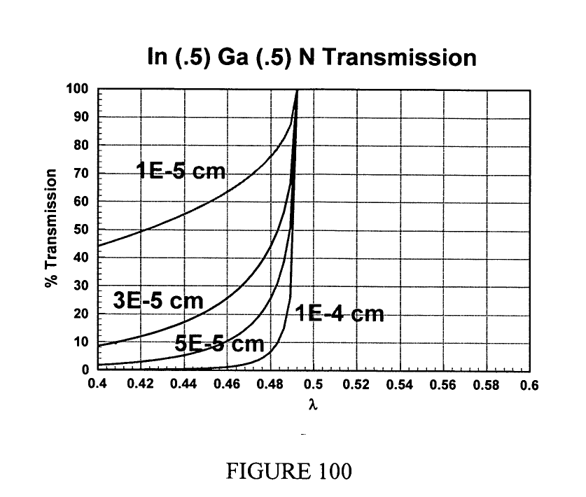

When the material is distributed in the form of very small particles with radii of 0.02 micron and smaller than the absorption follows essentially the theoretical curves, because scattering is negligible. To compare the band gap materials to Silicon we show in FIG. 99 and FIG. 100 the absorption due to thin InN and In_{0.5} Ga_{0.5} N layers. Small spheres without resonances with equal mass loadings would be slightly less absorbing than shown above. Resonances could improve the absorption characteristics. Nevertheless it appears that Silicon, especially in the amorphous form, is very competitive on a basis of absorption protection for a given mass loading or given thickness.

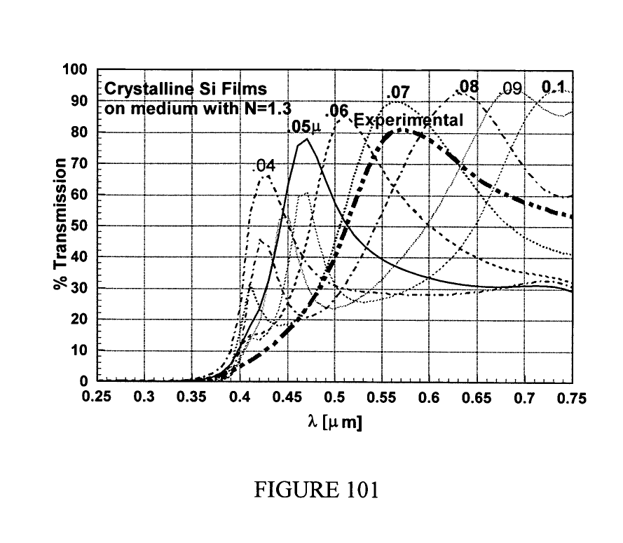

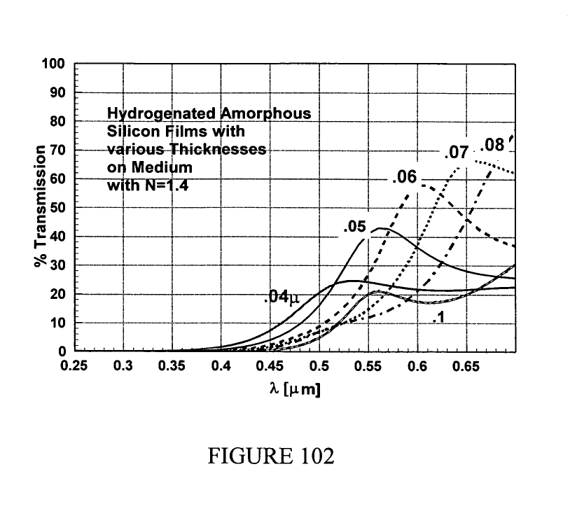

For comparison we show in FIG. 101 and FIG. 102 the transmission of crystalline and hydrogenated amorphous Silicon films with various thickness, resp. In these cases we have taken into account of the strong reflections at the film surface and at the interface with the substrate. This resonant trapping of the radiation can dramatically alter the absorption and the transmission of light and, for the right thickness, can make the protective properties of a film much better than it otherwise would be.

The reflections through interference give rise to transmission maxima and minima, which shift with greater film thickness to longer wavelengths. In this way stronger absorptions can be obtained where desired. The color of the transmitted light is strongly determined by the position of maximum transmission. This effect is so extraordinarily large for Silicon because of its large index of refraction. The large index discontinuities at the air—film and film—substrate interface lead to strong multiple reflections. In this way the absorption can be enhanced by a path length, which may include several traversals of the absorbing film. For hydrogenated amorphous Silicon there is a much stronger absorption in the visible, especially at the shorter wavelengths. The transmission curves in this case are presented in FIG. 102.

Conclusions

We have shown in detail three different ways of creating “physical color”. All the color effects are not based on the typical selective absorption processes in dye molecules. The destruction of the colorants through strong light and shorter wavelengths ultraviolet radiation is totally absent.

Closest to conventional pigments are nanoparticles exhibiting the Froehlich resonance effects. Here the color is essentially independent on the pigment particle size. The materials, which exhibit a strong Froehlich resonance, are TiN, ZrN, HfN and their alloys. Other metals exhibiting a Froehlich resonance have their resonance usually in the ultraviolet portion of the spectrum. However a thin coat of a high dielectric constant material can shift the resonance into the visible spectrum.

Materials such as Si, Si/Ge alloys and others exhibit the resonance effects in high dielectric constant nanospheres. Both of the above two methods can have absorption cross-sections much larger than unity and thus they can absorb much more light than a regular totally black (or other color) pigment of the same size. In other words less pigment will be required.

The above two effects have never been described in connection with their ability to make possible new colorants which will be virtually indestructible either by uv light or chemical attack. Because of the large absorption cross sections of up to 5 much less pigment will be required than with more conventional methods.

The third process described employs thin films of materials with a sharp cutoff in transmission towards shorter wavelengths. UV protection is easily accomplished. These materials also can be used to display interference colors depending on the thickness of the deposition.

1. An electromagnetic radiation-absorbing particle comprising:
(a) a core; and
(b) at least one shell,
wherein the shell encapsulates the core; and
wherein either the core or the shell comprises a conductive material, said material having a negative real part of the dielectric constant in a predetermined spectral band; and
wherein either
(i) the core comprises a first conductive material and the shell comprises a second conductive material different from the first conductive material; or
(ii) either the core or the shell comprises a refracting material.
